(19) United States
(12) Patent Application Publication
(10) Pub. No.: US 2024/0155360 A1
(43) Pub. Date: May 9, 2024

(54) COMMUNICATION DEVICE

(71) Applicant: SONY GROUP CORPORATION, TOKYO (JP)

(72) Inventors: KOSUKE AIO, TOKYO (JP); KEN TANAKA, TOKYO (JP); SHIGERU SUGAYA, TOKYO (JP)

(21) Appl. No.: 18/548,701

(22) PCT Filed: Jan. 14, 2022
(86) PCT No.: PCT/JP2022/001121

§ 371 Date: Sep. 1, 2023

(30) Foreign Application Priority Data
Mar. 15, 2021 (JP) 2021-041004

(51) Int. Cl. H04W 16/10

(52) U.S. Cl. CPC H04W 16/10; H04W 92/20

(57) ABSTRACT

The present technology relates to a communication device capable of performing coordinated transmission more flexibly. Provided is a communication device including a control unit that performs control to exchange control information used when performing coordinated transmission in which a plurality of communication devices performs data transmission in a coordinated manner with a first other communication device that coordinates by using a first transmission channel different from a second transmission channel used for wireless communication with a second other communication device serving as a transmission destination of data, and transmit a request signal that requests notification of an acquisition status of the control information to the first other communication device. The present technology can be applied to, for example, communication devices that form a wireless LAN system.

### TECHNICAL FIELD

The present technology relates to a communication device, and especially relates to a communication device capable of performing coordinated transmission more flexibly.

### BACKGROUND ART

An environment such as a stadium or a house in which a plurality of access points (APs) of a wireless local area network (LAN) is placed is on the increase, and a technology for coordinating access points to improve a system throughput and improve reliability has recently attracted attention.

For example, joint transmission (hereinafter, referred to as Joint Tx or JTx), which is one of the coordinated transmission schemes, causes a plurality of access points to perform coordinated transmission to one wireless terminal (station (STA)) using a multiple input and multiple output (MIMO) technology, and allows high-dimensional beamforming without increasing the number of antennas attached to an access point.

Furthermore, in coordinated transmission (hereinafter, referred to as Coordinated Tx or CTx) disclosed as another coordinated transmission scheme, each terminal performs at least one of frequency division, transmission power control, or beam formation so as to reduce an interference signal to a terminal that receives interference, thereby allowing a plurality of terminals to simultaneously transmit while preventing excessive deterioration in communication quality.

In any coordinated transmission scheme, it is necessary to exchange coordinated control information at least between the access points. The coordinated control information includes information regarding the wireless terminal of the transmission destination and the transmission time, transmission weight information to be used and the like. Although it is also supposed that the coordinated control information is exchanged via a wireless LAN, for example, a case where the information is exchanged between the access points via a high-speed backhaul such as a wired LAN cable or a millimeter wave band is also considered.

Patent Document 1 discloses a technology of setting a timeout in consideration of a backhaul delay and discarding information received when a delay occurs.

### CITATION LIST

### Patent Document

Patent Document 1: Japanese Patent Application Laid-Open No. 2017-17751

### SUMMARY OF THE INVENTION

### Problems to be Solved by the Invention

However, even if the access points are connected via a high-speed backhaul, there is a possibility that a delay occurs until the transmitted coordinated control information reaches depending on the situation. In this case, the access point has to wait for data transmission to the wireless terminal until the information exchange is completed via the backhaul, which causes overhead and degradation of the system capacity.

In the technology disclosed in Patent Document 1, information is discarded by providing a timeout in consideration of a backhaul delay, but it has been difficult to reduce the standby time of data transmission at the time of coordinated transmission only by the timeout for discarding information.

For this reason, when performing coordinated transmission, a technology for more flexibly performing coordinated transmission in consideration of a backhaul delay has been required.

The present technology has been achieved in view of such a situation, and is intended to more flexibly perform the coordinated transmission.

### Solutions to Problems

A communication device according to an aspect of the present technology is a communication device including: a control unit that performs control to exchange control information used when performing coordinated transmission in which a plurality of communication devices performs data transmission in a coordinated manner with a first other communication device that coordinates by using a first transmission channel different from a second transmission channel used for wireless communication with a second other communication device serving as a transmission destination of data, and transmit a request signal that requests notification of an acquisition status of the control information to the first other communication device.

In a communication device according to an aspect of the present technology, exchange of control information used when performing coordinated transmission in which a plurality of communication devices performs data transmission in a coordinated manner is performed with a first other communication device that coordinates by using a first transmission channel different from a second transmission channel used for wireless communication with a second other communication device serving as a transmission destination of data, and a request signal that requests notification of an acquisition status of the control information is transmitted to the first other communication device.

A communication device according to an aspect of the present technology is a communication device including a control unit that performs control to exchange control information used when performing coordinated transmission in which a plurality of communication devices performs data transmission in a coordinated manner with a first other communication device that coordinates by using a first transmission channel different from a second transmission channel used for wireless communication with a second other communication device serving as a transmission destination of data, receive a request signal that requests notification of an acquisition status of the control information transmitted from the first other communication device, and transmit a response signal including the acquisition status of the control information to the first other communication device on the basis of information included in the request signal.

In a communication device according to an aspect of the present technology, exchange of control information used when performing coordinated transmission in which a plurality of communication devices performs data transmission in a coordinated manner is performed with a first other communication device that coordinates by using a first transmission channel different from a second transmission channel used for wireless communication with a second other communication device serving as a transmission destination of data, a request signal that requests notification of an acquisition status of the control information transmitted from the first other communication device is received, and a response signal including the acquisition status of the control information is transmitted to the first other communication device on the basis of information included in the request signal.

A communication device according to an aspect of the present technology is a communication device serving as a transmission destination of data transmitted from a plurality of communication devices that performs coordinated transmission in which data transmission is performed in a coordinated manner, the communication device including a control unit that performs control to set and update a transmission suppression period on the basis of a request signal that requests notification of an acquisition status of control information used when performing the coordinated transmission and a response signal that is a response to the request signal transmitted from another communication device.

In a communication device according to an aspect of the present technology, the communication device serving as a transmission destination of data transmitted from a plurality of communication devices that performs coordinated transmission in which data transmission is performed in a coordinated manner sets and updates a transmission suppression period on the basis of a request signal that requests notification of an acquisition status of control information used when performing the coordinated transmission and a response signal that is a response to the request signal transmitted from another communication device.

Note that, a communication device according to one aspect of the present technology may be an independent device, or may be an internal block forming one device.

### BRIEF DESCRIPTION OF DRAWINGS

FIG. 1 is a diagram illustrating a configuration example of a network system to which the present technology is applied.

FIG. 2 is a block diagram illustrating a configuration example of a communication device to which the present technology is applied.

FIG. 3 is a diagram illustrating an operation example of coordinated transmission of a current scheme.

FIG. 4 is a sequence diagram illustrating exchange between devices in a first embodiment along a time axis.

FIG. 5 is a diagram illustrating a configuration example of a Coordination Setup Request frame.

FIG. 6 is a diagram illustrating a configuration example of a Coordination Setup Response frame.

FIG. 7 is a diagram illustrating a configuration example of a Coordination Setup Initialization frame.

FIG. 8 is a diagram illustrating a configuration example of a Coordination Ready Request frame.

FIG. 9 is a diagram illustrating a configuration example of a Coordination Ready Response frame.

FIG. 10 is a diagram illustrating a configuration example of a Coordination Trigger frame.

FIG. 11 is a flowchart for illustrating a flow of processing when a Master AP becomes a Sharing AP.

FIG. 12 is a flowchart for illustrating a flow of processing when the Master AP becomes a Sharing AP.

FIG. 13 is a flowchart for illustrating a flow of processing when a non-Master AP becomes the Shared AP.

FIG. 14 is a flowchart for illustrating a flow of processing when the non-Master AP becomes the Sharing AP.

FIG. 15 is a flowchart for illustrating a flow of processing when the non-Master AP becomes the Sharing AP.

FIG. 16 is a flowchart for illustrating a flow of processing when the Master AP becomes the Shared AP.

FIG. 17 is a flowchart for illustrating a flow of processing by a wireless terminal STA.

FIG. 18 is a diagram illustrating a first operation example of the coordinated transmission to which the present technology is applied.

FIG. 19 is a diagram illustrating a second operation example of the coordinated transmission to which the present technology is applied.

FIG. 20 is a diagram illustrating a configuration example of a Coordination Ready Request frame.

FIG. 21 is a diagram illustrating a configuration example of a Coordination Ready Response frame.

FIG. 22 is a flowchart for illustrating a flow of processing when the Master AP becomes the Sharing AP.

FIG. 23 is a flowchart for illustrating a flow of processing when the Master AP becomes the Sharing AP.

FIG. 24 is a flowchart for illustrating a flow of processing when the non-Master AP becomes the Shared AP.

FIG. 25 is a flowchart for illustrating a flow of processing when the non-Master AP becomes the Sharing AP.

FIG. 26 is a flowchart for illustrating a flow of processing when the non-Master AP becomes the Sharing AP.

FIG. 27 is a flowchart for illustrating a flow of processing when the Master AP becomes the Shared AP.

### MODE FOR CARRYING OUT THE INVENTION

(System Configuration Example)

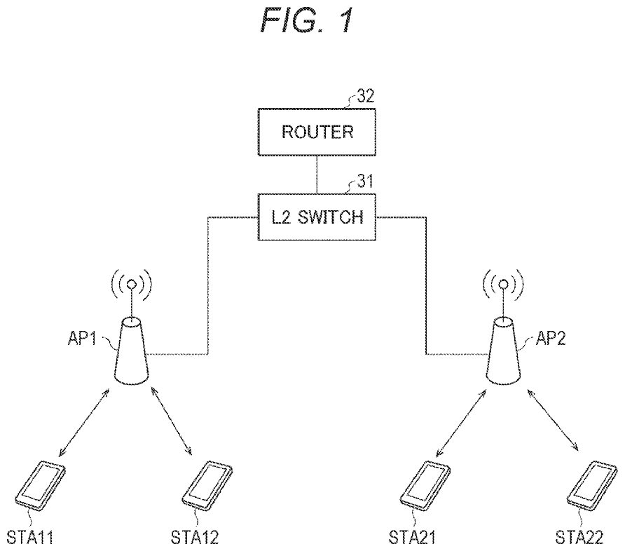

FIG. 1 is a diagram illustrating a configuration example of a network system to which the present technology is applied.

In FIG. 1, two access points AP1 and AP2 and four wireless terminals STA11, STA12, STA21, and STA22 form a wireless LAN system. The wireless terminals STA11 and STA12 are connected to the access point AP1, and the wireless terminals STA21 and STA22 are connected to the access point AP2.

The access point AP1 and the access point AP2 are connected to each other by wire via an L2 switch 31. The L2 switch 31 is connected to a router 32, and the access point AP1 and the access point AP2 are under the control of the same router 32 and are both connected in the same network.

Here, when Joint Tx is performed as a coordinated transmission scheme, an access point that can play a role of generating transmission weight information to be described later and transmitting the same to another access point is referred to as a Master AP, and an access point that cannot play this role is referred to as a non-Master AP.

Hereinafter, unless otherwise specified, the access point AP1 is described as the Master AP, and the access point AP2 is described as the non-Master AP. Note that, actually, it is sufficient that at least one access point capable of exchanging information with all the access points in a coordinated access point group is present and operates as the Master AP. For example, in the following description, both the access points AP1 and AP2 may operate as the Master AP.

In FIG. 1, the access point AP1 and the wireless terminals STA11 and STA12 exchange signals by a wireless LAN via a fronthaul (fronthaul link). Furthermore, the access point AP2 and the wireless terminals STA21 and STA22 exchange signals by a wireless LAN via a fronthaul (fronthaul link).

The access point AP1 and the access point AP2 exchange signals by a wired LAN via a backhaul (backhaul link) including the L2 switch 31 and the router 32. Furthermore, the access point AP1 and the access point AP2 may exchange signals by a wireless LAN via a fronthaul (fronthaul link). Here, the link is intended to mean a transmission channel for performing data transmission between a plurality of communication devices.

Note that, a target system configuration is not limited to the configuration illustrated in FIG. 1; it is only required that a plurality of communication devices between which a connection is established be present, and a communication device be present as a peripheral terminal for each communication device, and no specific positional relationship is required as long as the above-described conditions are satisfied.

(Configuration Example of Device)

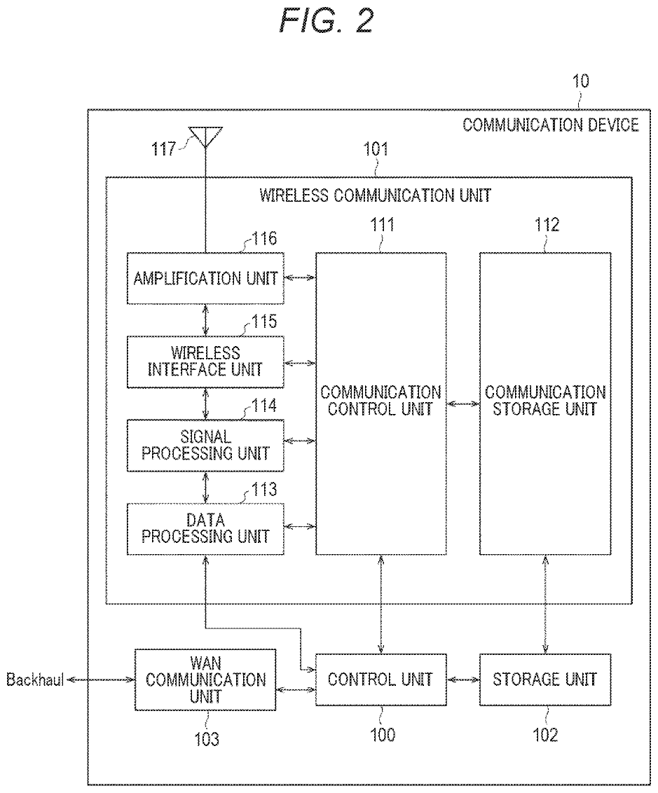

FIG. 2 is a diagram illustrating a configuration example of a communication device to which the present technology is applied.

A communication device 10 is configured as the access point AP in FIG. 1. The communication device 10 includes a control unit 100, a wireless communication unit 101, a storage unit 102, and a WAN communication unit 103. An antenna 117 is connected to the wireless communication unit 101.

The wireless communication unit 101 includes a communication control unit 111, a communication storage unit 112, a data processing unit 113, a signal processing unit 114, a wireless interface unit 115, and an amplification unit 116.

The communication control unit 111 controls an operation of each unit and information transmission between the units. Furthermore, the communication control unit 111 performs control to transfer, to the data processing unit 113, control information and management information notification of which is to be provided to another communication device.

The communication storage unit 112 holds information to be used by the communication control unit 111. Furthermore, the communication storage unit 112 holds a packet to be transmitted and a received packet. A transmission buffer that holds the packet to be transmitted is included in the communication storage unit 112.

At the time of transmission, the data processing unit 113 performs sequence management of data held in the communication storage unit 112 and the control information and management information received from the communication control unit 111, performs encryption processing and the like, and then adds a media access control (MAC) header and an error detection code thereto to generate a packet. The data processing unit 113 performs concatenation processing on a plurality of the generated packets. Furthermore, at the time of reception, the data processing unit 113 performs deconcatenation processing on the MAC header of the received packet, analysis and error detection, and retransmission request operation reorder processing.

At the time of transmission, the signal processing unit 114 performs encoding, interleaving, modulation and the like on the packet and adds a physical (PHY) header thereto to generate a symbol stream. Furthermore, at the time of reception, the signal processing unit 114 analyzes the PHY header and performs demodulation, deinterleaving, decoding and the like on the symbol stream to generate a packet. The signal processing unit 114 performs complex channel characteristic estimation and spatial separation processing as necessary.

At the time of transmission, the wireless interface unit 115 performs digital-analog signal conversion, filtering, up-conversion, and phase control on the symbol stream to generate a transmission signal. Furthermore, at the time of reception, the wireless interface unit 115 performs down-conversion, filtering, and analog-digital signal conversion on a received signal to generate a symbol stream.

The amplification unit 116 amplifies a signal input from the wireless interface unit 115 or the antenna 117. A part of the amplification unit 116 may be a component outside the wireless communication unit 101. Furthermore, a part of the amplification unit 116 may be included in the wireless interface unit 115.

The control unit 100 controls (the communication control unit 111 of) the wireless communication unit 101. Furthermore, the control unit 100 may perform a part of the operation of the communication control unit 111 in place of the same. The control unit 100 and the communication control unit 111 may be configured as one block.

The storage unit 102 holds information to be used by the control unit 100 and the wireless communication unit 101. Furthermore, the storage unit 102 may perform a part of the operation of the communication storage unit 112 in place of the same. The storage unit 102 and the communication storage unit 112 may be configured as one block.

The WAN communication unit 103 decodes the packet acquired from the backhaul and transfers the same to the wireless communication unit 101 via the control unit 100. The packet herein transferred may be in a state in which an IP header remains as it is (access point mode) or a state in which the IP header is decoded by the WAN communication unit 103 to be removed (router mode).

Note that, in FIG. 2, it is supposed that the wireless communication unit 101 is configured as one integrated circuit (IC), but the configuration of the IC to which the present technology is applied is not limited to this. For example, the wireless interface unit 115 may be mounted as another IC. Furthermore, FIG. 2 illustrates a case where the communication device 10 is configured as the access point AP in FIG. 1; however, in a case where this is configured as the wireless terminal STA, for example, the WAN communication unit 103 is only required to be removed, and the control unit 100, the wireless communication unit 101, and the storage unit 102 are only required to form the communication device 10.

(Outline of Present Technology)

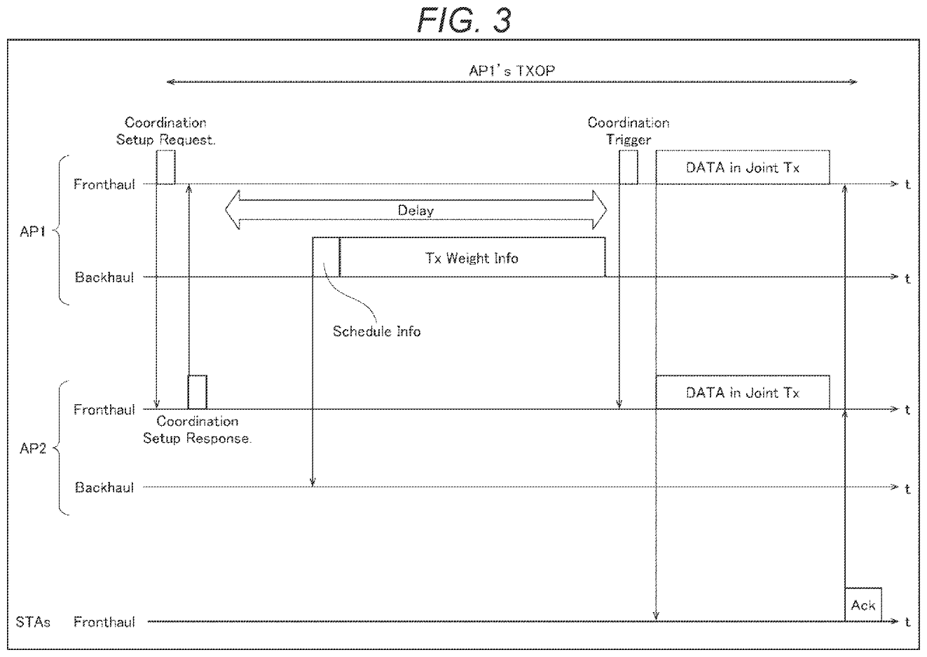

Here, for comparison with the operation of the coordinated transmission to which the present technology is applied, an operation of the coordinated transmission of a current scheme will be described. FIG. 3 is a diagram illustrating an operation example of the coordinated transmission of the current scheme.

In FIG. 3, the exchange of the signals among the access point AP1, the access point AP2, and a plurality of wireless terminals STAs in the fronthaul, and the exchange of the signals between the access point AP1 and the access point AP2 in the backhaul are represented along a time axis in a direction from a left side to a right side in the drawing.

FIG. 3 illustrates an example in which the access point AP1 as the Master AP acquires a transmission right. Furthermore, it is supposed that sharing of data required for performing the Joint Tx is already completed.

First, the access point AP1 exchanges a Coordination Setup Request frame and a Coordination Setup Response frame with the access point AP2 and collects various pieces of information. The information herein collected includes, for example, information such as whether or not the access point AP2 can perform the coordinated transmission, whether or not the data required for performing the Joint Tx can be shared, and to which wireless terminal STA the packet is to be transmitted at the present time.

Next, the access point AP1 generates schedule information (Schedule Info) and transmission weight information (Tx Weight Info) when performing the Joint Tx on the basis of the collected information, and transmits the same to the access point AP2 via the backhaul.

The schedule information includes information regarding the wireless terminal STA to which the packet is transmitted, the packet to be transmitted, and a transmission parameter with which the packet is transmitted. The transmission weight information includes vector information that should be processed by a wireless interface required at the time of MIMO processing. Note that, both the schedule information and transmission weight information are essential when performing the Joint Tx, but it is only required to transmit and acquire the schedule information when performing Coordinated Tx.

After the transmitted schedule information and transmission weight information are received by the access point AP2 and the Joint Tx is ready, the access point AP1 transmits a Coordination Trigger frame to the access point AP2 and starts data transmission by the Joint Tx.

The wireless terminal STA receives the data transmitted by the Joint Tx from the access point AP1 and the access point AP2, and transmits acknowledgement (Ack) as a reception response thereto. The access point AP1 and the access point AP2 receive the Ack from the wireless terminal STA, and finish a series of processing. It is considered that the Ack is transmitted using multi-user communication such as uplink orthogonal frequency division multiple access (UL OFDMA), and notification of all pieces of information required for this is provided together with the data transmitted by the Joint Tx.

Note that, in a case where there is a margin in channel occupancy time (transmission opportunity (TXOP)) after the data transmission by the Joint Tx is finished, the data transmission by the Joint Tx may be performed again, or the data transmission may be performed by using another scheme. Moreover, even if the TXOP remains, the processing may be finished at that time.

Furthermore, although it is not herein illustrated, when the access point AP2 as the non-Master AP acquires the transmission right, the access point AP2 transmits a Coordination Setup Initialization frame to the access point AP1. Therefore, the access point AP2 as the non-Master AP requests the access point AP as the Master AP to generate the schedule information and transmission weight information used in coordinated transmission processing.

In a case where there is an access point AP as a coordination candidate in addition to the access point AP2, the access point AP1 as the Master AP may exchange the Coordination Setup Request frame and the Coordination Setup Response frame with another access point AP to generate the schedule information and transmission weight information as illustrated in FIG. 3 after receiving the Coordination Setup Initialization frame.

Incidentally, a transmission time between terminals via the wired LAN is generally shorter than that via the wireless LAN. However, a transmission delay via the backhaul might occur depending on a network status. Specifically, for example, the following case is supposed.

That is, first, when the category of the wired LAN is old and the maximum speed is not sufficient, and second, when a traffic with high priority continues flowing from the router 32 to the L2 switch 31 and a buffer of the L2 switch 31 is accumulated, the transmission delay via the backhaul is supposed to occur.

When falling into such a transmission delay situation, the access point AP1 cannot proceed to next processing until transmission of coordinated control information to the access point AP2 is completed, so that transmission efficiency is significantly reduced with an increase in overhead. Moreover, since the wireless LAN terminal mainly has no means to know a higher-layer network status, it is not possible to know when the information transmitted via the backhaul reaches the other party, and in the coordinated transmission of the current scheme, it is conceivable that the access point AP1 provides an instruction to start a coordinated operation at a stage where the access point AP2 does not acquire sufficient information.

Therefore, in the coordinated transmission including the Joint Tx in the wireless LAN, it has been required to check whether or not the coordinated control information notification of which is provided via the backhaul is correctly acquired, and to flexibly determine to perform the Joint Tx and to switch to another coordinated transmission scheme according to a status of the other party.

Therefore, the present technology proposes a method of more flexibly determining to perform the Joint Tx and switching to another coordinated transmission scheme or another transmission scheme without providing unnecessary standby time by sharing an acquisition status of the coordinated control information transmitted via the backhaul between the access points APs before performing the coordinated transmission. Hereinafter, embodiments of the present technology will be described with reference to the drawings.

### 1. First Embodiment

(Overall Sequence Diagram)

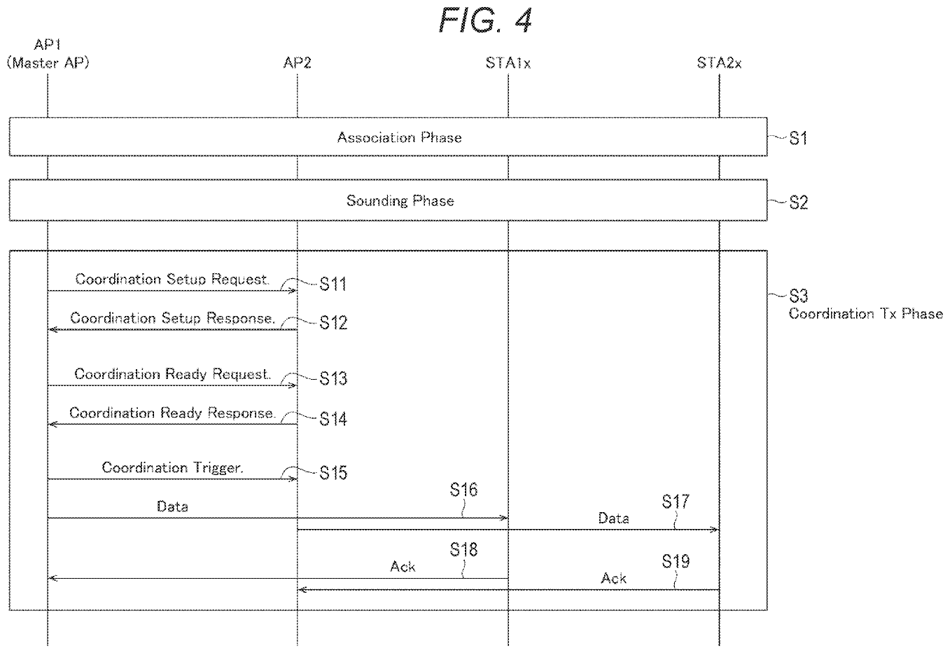

FIG. 4 is a sequence diagram illustrating exchange between devices in a first embodiment along a time axis. In this sequence diagram, it is described while dividing the same into three phases of an Association Phase (S1), a Sounding Phase (S2), and a Coordination Tx Phase (S3).

In the Association Phase (S1), processing of connecting an access point AP and a wireless terminal STA in the same cell and processing of connecting the access points APs for a coordinated operation are performed. Information regarding the wireless terminal STA in each basic service set (BSS) and capability information of each device are exchanged in the Association Phase. For example, the capability information includes information regarding capability such as capability for a Joint Tx operation and capability for a Coordinated Tx operation.

In the Sounding Phase (S2), a channel is measured between the access point AP and the wireless terminal STA and feedback information is acquired. When performing the Joint Tx, the Master AP is at least required to acquire channel information or feedback information of all AP-STA links. When performing the Coordinated Tx, all the access points APs is required to acquire the channel information or feedback information between themselves and all the wireless terminal STAB.

In the Coordination Tx Phase (S3), the access points APs perform data transmission in a coordinated manner (S11 to S19). In the present technology, before the coordinated transmission starts, it is checked whether coordinated control information transmitted via a backhaul reaches another access point AP and is ready for coordinated transmission by exchange between a Coordination Ready Request frame and a Coordination Ready Response frame (S13 and S14). For example, the coordinated control information includes information such as schedule information and transmission weight information.

Here, it becomes possible to select an efficient data transmission method even in a case where a delay in backhaul transmission occurs by allowing information required for selecting whether to stand by for data transmission, transmit by one access point AP, or perform transmission by the Coordinated Tx when all pieces of coordinated control information do not reach to be included in the Coordination Ready Response frame for notification.

Note that, in FIG. 4, the order and processing timing of each phase are not limited to those illustrated, and for example, the Sounding Phase may be necessarily performed before the Coordination Tx Phase, or the Coordination Tx Phase may be continuously performed.

(S3: Coordination Tx Phase)

The Coordination Tx Phase (S3 in FIG. 4) in the overall sequence diagram will be described in detail.

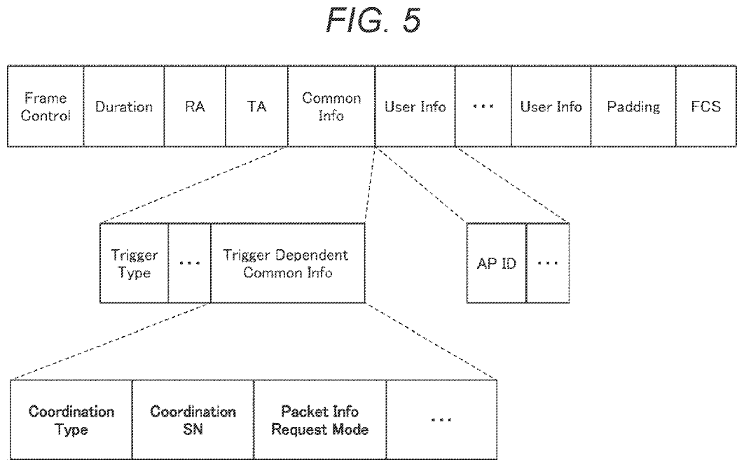

In the Coordination Tx Phase, first, a Coordination Setup Request frame is transmitted from an access point AP1 to an access point AP2 (S11 in FIG. 4). FIG. 5 is a diagram illustrating a configuration example of the Coordination Setup Request frame.

In FIG. 5, the Coordination Setup Request frame includes Frame Control, Duration, RA, TA, Common Info, User Info, Padding, and FCS. Here, a configuration based on a Trigger frame defined in IEEE 802.11ax is illustrated.

The Frame Control includes information indicating a type of the frame. The Duration includes information indicating a length of the frame. The receiver address (RA) includes a receiver address. The transmitter address (TA) includes a transmitter address.

The frame includes Common Info and User Info as a main body of information to be transmitted. Furthermore, the Padding, which is a dummy signal inserted in a case where a frame reception time is extended, and a frame check sequence (FCS) as an error correction code are added to the frame.

The Common Info includes a common information group notification of which is provided to a plurality of receivers. The Common Info includes fields of Trigger Type and Trigger Dependent Common Info. Note that, in addition to these fields, the Common Info includes information common to the access points APs required for transmitting the Coordination Setup Response frame.

The Trigger Type includes information indicating the type of the Trigger frame. Here, information indicating that the frame is the “Coordination Setup Request frame” is included.

The Trigger Dependent Common Info includes an individual information group for each type of the Trigger frame. The Trigger Dependent Common Info includes fields of Coordination Type, Coordination SN, and Packet Info Request Mode.

The Coordination Type includes information indicating a candidate for the coordinated transmission scheme. For example, in a case where there are the Coordinated Tx and Joint Tx as the coordinated transmission scheme, a two-bit field can be provided as the Coordination Type, and “00” can be set to “None”, “01” can be set to “Coordinated Tx only”, “10” can be set to “Joint Tx only”, and “11” can be set to “Both”. Alternatively, notification may be provided by another method such as providing one bit of each of “Coordinated Tx Enabler flag” and “Joint Tx Enabler flag”. Note that, not only the Coordinated Tx and Joint Tx but also other coordinated transmission schemes may be included to be set.

Coordination Sequence Number (SN) includes information (processing information) indicating a processing number of the coordinated transmission. The Coordination SN is set when the access point AP that acquires the TXOP starts processing, and the same sequence number is assigned in subsequent processing thereafter.

The Packet Info Request Mode includes information indicating a mode regarding notification of packet information regarding a stored (held) packet of which notification is provided by the Coordination Setup Response frame.

For example, it is possible to provide one bit of a flag as the Packet Info Request Mode, and set so that notification of only the packet information addressed to the wireless terminal STA to which it is currently about to transmit is provided in a case where this is “0”, and notification of the packet information addressed to all the stored (held) wireless terminals STAB is provided in a case where this is “1”. Furthermore, it is also possible to provide notification of STA ID and limit the wireless terminal STA of the destination that responds.

The User Info includes an individual information group notification of which is provided to a plurality of receivers. The User Info includes a field of AP ID. Note that, the User Info includes, in addition to these fields, information for each access point AP required for transmitting the Coordination Setup Response frame.

The AP ID includes identification information of the access point AP from which the Coordination Setup Response frame is desired to be acquired. For example, as the identification information, a MAC address, BSS Color, and some other information capable of identifying the access point AP can be used.

Note that, the Coordination Setup Request frame may have another configuration in addition to the frame configuration illustrated in FIG. 5 as long as at least the Coordination Type, Coordination SN, Packet Info Request Mode are included.

Furthermore, the frame is based on the premise that response signals from a plurality of access points APs are acquired, but in a case where there is only one access point AP from which a response signal is desired to be acquired, the frame may be transmitted as an Action frame as long as the above-described information is included. Moreover, although the frame is supposed to be the MAC Frame, this may be transmitted as a TCP/IP Frame as long as the above-described information is included.

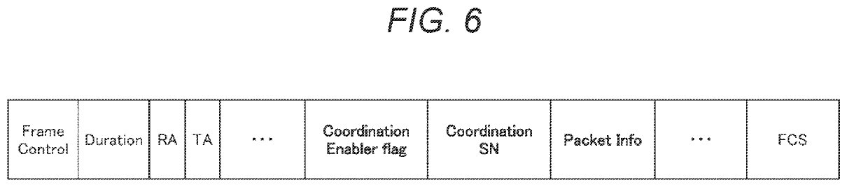

Subsequently, in the Coordination Tx Phase (S3 in FIG. 4), the Coordination Setup Response frame, which is a response to the Coordination Setup Request frame, is transmitted from the access point AP2 to the access point AP1 (S12 in FIG. 4). FIG. 6 is a diagram illustrating a configuration example of the Coordination Setup Response frame.

In FIG. 6, the Coordination setup Response frame includes Frame Control, Duration, RA, TA, Coordination Enabler flag, Coordination SN, Packet Info, and FCS. Here, a configuration based on an Action frame defined in IEEE 802.11 is illustrated.

The Frame Control includes information indicating a type of the frame. The Duration includes information indicating a length of the frame. The RA includes a receiver address. The TA includes a transmitter address.

The frame includes Coordination Enabler flag, Coordination SN, and Packet Info as a main body of information to be transmitted. Furthermore, the FCS is added to the frame as an error correction code.

The Coordination Enabler flag includes information indicating a candidate for the coordinated transmission scheme that may be performed. For example, in a case where there are the Coordinated Tx and Joint Tx as the coordinated transmission scheme, a two-bit field can be provided as the Coordination Enabler flag, and “00” can be set to “None”, “01” can be set to “Coordinated Tx only”, “10” can be set to “Joint Tx only”, and “11” can be set to “Both”. Alternatively, notification may be provided by another method such as providing one bit of each of “Coordinated Tx Enabler flag” and “Joint Tx Enabler flag”. Note that, not only the Coordinated Tx and Joint Tx but also other coordinated transmission schemes may be included to be set.

Coordination Sequence Number (SN) includes information indicating a processing number of the coordinated transmission. This processing information includes the same sequence number as that of the Coordination SN of the Coordination Setup Request frame (FIG. 5).

The Packet Info includes packet information regarding a stored (held) packet. For example, the packet information includes an information group and the like in which at least identification information of the wireless terminal STA to be the destination, a traffic indication (TID), an access category (AC), and a buffer size are associated with one another. The packet information may include the sequence number assigned to each packet for the Joint Tx. The information of the wireless terminal STA herein required is processed in accordance with the Packet Info Request Mode of the Coordination Setup Request frame (FIG. 5).

Note that, the Coordination Setup Response frame may have another configuration in addition to the frame configuration illustrated in FIG. 6 as long as at least the Coordination Enabler flag, Coordination SN, and Packet Info are included. Furthermore, although the frame is supposed to be the MAC Frame, this may be transmitted as a TCP/IP Frame as long as the above-described information is included.

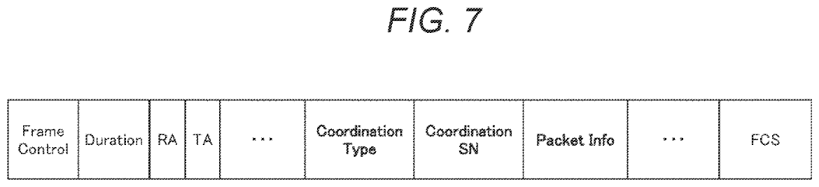

Here, when the access point AP2 acquires the transmission right, the Coordination Setup Initialization frame is transmitted from the access point AP2 to the access point AP1. FIG. 7 is a diagram illustrating a configuration example of the Coordination Setup Initialization frame.

In FIG. 7, the Coordination Setup Initialization frame includes Frame Control, Duration, RA, TA, Coordination Type, Coordination SN, Packet Info, and FCS. Here, a configuration based on an Action frame defined in IEEE 802.11 is illustrated.

The Frame Control includes information indicating a type of the frame. The Duration includes information indicating a length of the frame. The RA includes a receiver address. The TA includes a transmitter address.

The frame includes Coordination Type, Coordination SN, and Packet Info as a main body of information to be transmitted. Furthermore, the FCS is added to the frame as an error correction code.

The Coordination Type includes information indicating a candidate for the coordinated transmission scheme. For example, in a case where there are the Coordinated Tx and Joint Tx as the coordinated transmission scheme, a two-bit field can be provided as the Coordination Type, and “00” can be set to “None”, “01” can be set to “Coordinated Tx only”, “10” can be set to “Joint Tx only”, and “11” can be set to “Both”. Alternatively, notification may be provided by another method such as providing one bit of each of “Coordinated Tx Enabler flag” and “Joint Tx Enabler flag”. Note that, not only the Coordinated Tx and Joint Tx but also other coordinated transmission schemes may be included to be set.

Coordination Sequence Number (SN) includes information indicating a processing number of the coordinated transmission. The Coordination SN is set when the access point AP that acquires the TXOP starts processing, and the same sequence number is assigned in subsequent processing thereafter.

The Packet Info includes packet information regarding a stored (held) packet. For example, the packet information includes an information group in which at least the identification information of the wireless terminal STA to be the destination, TID, access category, and buffer size are associated with one another. As the packet information, notification of the sequence number recognized by each access point AP may be provided for the Joint Tx. The information of the wireless terminal STA herein required may be determined by the access point AP itself.

Note that, the Coordination Setup Initialization frame may have another configuration in addition to the frame configuration illustrated in FIG. 7 as long as at least the Coordination Type, Coordination SN, and packet Info are included. Furthermore, although the frame is supposed to be the MAC Frame, this may be transmitted as a TCP/IP Frame as long as the above-described information is included.

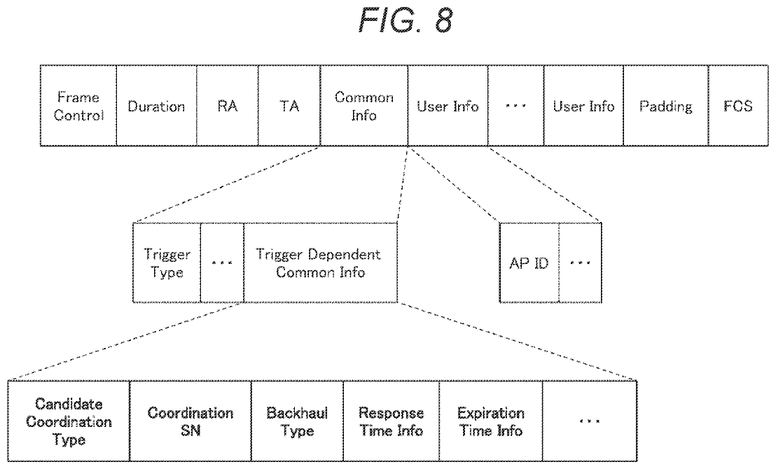

Subsequently, in the Coordination Tx Phase (S3 in FIG. 4), the Coordination Ready Request frame is transmitted from the access point AP1 to the access point AP2 (S13 in FIG. 4). FIG. 8 is a diagram illustrating a configuration example of the Coordination Ready Request frame.

In FIG. 8, the Coordination Ready Request frame includes Frame Control, Duration, RA, TA, Common Info, User Info, Padding, and FCS. Here, a configuration based on a Trigger frame defined in IEEE 802.11ax is illustrated.

The Frame Control includes information indicating a type of the frame. The Duration includes information indicating a length of the frame. The RA includes a receiver address. The TA includes a transmitter address.

The frame includes the Common Info and User Info as a main body of information to be transmitted. Furthermore, the Padding and FCS are added to the frame.

The Common Info includes fields of Trigger Type and Trigger Dependent Common Info as a common information group notification of which is provided to a plurality of receivers. Note that, the Common Info includes, in addition to these fields, information common to the access point AP required for transmitting the Coordination Ready Response frame.

The Trigger Type includes information indicating the type of the Trigger frame. Here, information indicating that the frame is the “Coordination Ready Request frame” is included.

The Trigger Dependent Common Info includes fields of Candidate Coordination Type, Coordination SN, Backhaul Type, Response Time Info, and Expiration Time Info as an individual information group for each type of the Trigger frame.

The Candidate Coordination Type includes information indicating a candidate for the coordinated transmission scheme. For example, in a case where there are the Coordinated Tx and Joint Tx as the coordinated transmission scheme, it is possible to provide two bits as the Candidate Coordination Type, and “00” can be set to “None”, “01” can be set to “Coordinated Tx”, and “10” can be set to “Joint Tx”. Alternatively, notification may be provided by another method such as providing one bit of each of “Coordinated Tx Enabler flag” and “Joint Tx Enabler flag”. Note that, not only the Coordinated Tx and Joint Tx but also other coordinated transmission schemes may be included to be set.

Coordination Sequence Number (SN) includes information indicating a processing number of the coordinated transmission. The sequence number designated first is designated in the Coordination SN.

The Backhaul Type includes information regarding a communication network that transmits the coordinated control information, which is control information for the coordinated transmission. For example, it is possible to provide two bits as the Backhaul Type, and “00” can be set to “fronthaul (a wireless link the same as AP-STA)”, “01” can be set to “wireless backhaul (a wireless link dedicated to AP-AP)”, and “10” can be set to a “wired backhaul (an AP-AP link via a wired network)”. There is no limitation to this example, and a plurality of types may be designated as the Backhaul Type.

The Response Time Info includes information (time information) indicating an acquisition time of the response signal. For example, it is possible to provide two bits as the Response Time Info, and “00” can be set to “16 us”, “01” can be set to “64 us”, “10” can be set to “256 us”, and “11” can be set to “1024 us”. It is set that 16 us is a time equivalent to a short inter frame space (SIFS). Note that, a bit depth and granularity are not limited thereto. Furthermore, there is no limitation to this example, and for example, a calculation formula that can calculate a standby time from a numerical value indicated by a bit may be defined.

The Expiration Time Info includes information indicating a valid time of the transmitted control information. For example, it is possible to provide two bits as the Expiration Time Info, and “00” can be set to “1 ms”, “01” can be set to “2 ms”, “10” can be set to “3 ms”, and “11” can be set to “4 ms”. Note that, a bit depth and granularity are not limited thereto. Furthermore, there is no limitation to this example, and for example, a calculation formula that can calculate a standby time from a numerical value indicated by a bit may be defined.

The User Info includes an AP ID including identification information of an access point AP for which the Coordination Ready Response frame is desired to be acquired as an individual information group of which notification is provided to a plurality of receivers. For example, as the identification information, a MAC address, BSS Color, and some other information capable of identifying the access point AP can be used.

Note that, the Coordination Ready Request frame may have another configuration in addition to the frame configuration illustrated in FIG. 8 as long as at least the Candidate Coordination Type, Coordination SN, Backhaul Type, Response Time Info, and Expiration Time Info are included.

Furthermore, the frame is based on the premise that response signals from a plurality of access points APs are acquired, but in a case where there is only one access point AP from which a response signal is desired to be acquired, the frame may be transmitted as an Action frame as long as the above-described information is included. Furthermore, although the frame is supposed to be the MAC Frame, this may be transmitted as a TCP/IP Frame as long as the above-described information is included.

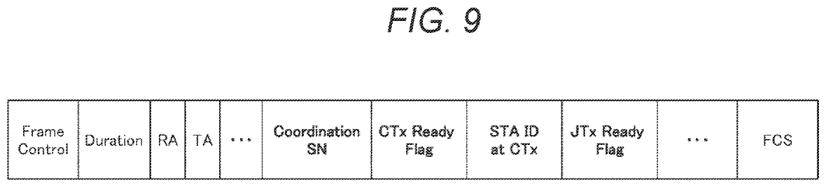

Subsequently, in the Coordination Tx Phase (S3 in FIG. 4), the Coordination Ready Response frame, which is a response to the Coordination Ready Request frame, is transmitted from the access point AP2 to the access point AP1 (S14 in FIG. 4). FIG. 9 is a diagram illustrating a configuration example of the Coordination Ready Response frame.

In FIG. 9, the Coordination Ready Response frame includes Frame Control, Duration, RA, TA, Coordination SN, CTx Ready Flag, STA ID at CTx, JTx Ready Flag, and FCS. Here, a configuration based on an Action frame defined in IEEE 802.11 is illustrated.

The Frame Control includes information indicating a type of the frame. The Duration includes information indicating a length of the frame. The RA includes a receiver address. The TA includes a transmitter address.

The frame includes, as a main body of the information to be transmitted, the Coordination SN, CTx Ready Flag, STA ID at CTx, and JTx Ready Flag. Furthermore, the FCS is added to the frame.

Coordination Sequence Number (SN) includes information indicating a processing number of the coordinated transmission. The sequence number designated first is designated as the sequence SN.

The CTx Ready Flag includes flag information (preparation state information) indicating that the schedule information included in the coordinated control information transmitted from the Master AP is acquired and the preparation of the Coordinated Tx is completed. For example, it is possible to provide a one-bit field as the CTx Ready Flag, and “0” can be set to “false” and “1” can be set to “true”. Furthermore, also in a case where the packet to be transmitted by the Coordinated Tx is not stored (held), “0” may be set.

The STA ID at CTx includes destination information of the wireless terminal STA to which this is scheduled to be transmitted when performing the Coordinated Tx. For example, an association ID (AID), a MAC address and the like can be used as the destination information. A plurality of pieces of destination information may be designated.

The JTx Ready Flag includes flag information indicating that the schedule information and transmission weight information included in the coordinated control information transmitted from the Master AP are acquired and the preparation of the Joint Tx is completed. For example, it is possible to provide a one-bit field as the JTx Ready Flag, and “0” can be set to “false” and “1” can be set to “true”. Furthermore, also in a case where the packet to be transmitted by the Joint Tx is not stored (held), “0” may be set.

Note that, the Coordination Ready Response frame may have another configuration in addition to the frame configuration illustrated in FIG. 9 as long as at least the Coordination SN, Ctx Ready Flag, STA ID at CTx, and JTx Ready flag are included. Furthermore, although the frame is supposed to be the MAC Frame, this may be transmitted as a TCP/IP Frame as long as the above-described information is included.

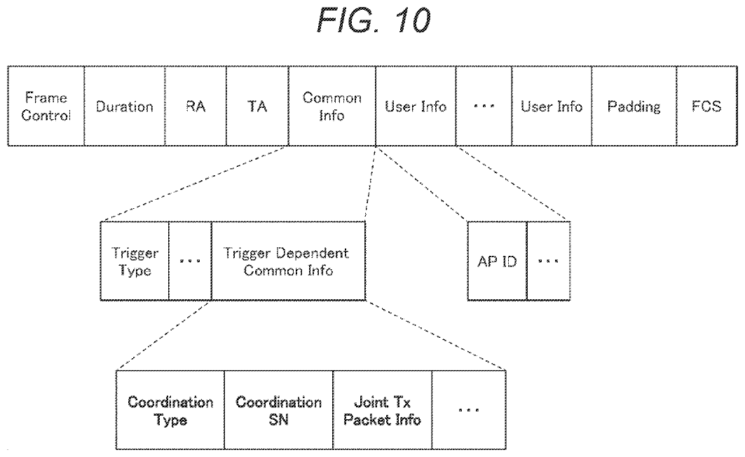

Subsequently, in the Coordination Tx Phase (S3 in FIG. 4), the Coordination Trigger frame is transmitted from the access point AP1 to the access point AP2 (S15 in FIG. 4). FIG. 10 is a diagram illustrating a configuration example of the Coordination Trigger frame.

In FIG. 10, the Coordination Trigger frame includes Frame Control, Duration, RA, TA, Common Info, User Info, Padding, and FCS. Here, a configuration based on a Trigger frame defined in IEEE 802.11ax is illustrated.

The Frame Control includes information indicating a type of the frame. The Duration includes information indicating a length of the frame. The RA includes a receiver address. The TA includes a transmitter address.

The frame includes the Common Info and User Info as a main body of information to be transmitted. Furthermore, the Padding and FCS are added to the frame.

The Common Info includes fields of Trigger Type and Trigger Dependent Common Info as a common information group notification of which is provided to a plurality of receivers. Note that, the Common Info includes, in addition to these fields, information common to each access point AP required for transmitting the frame.

The Trigger Type includes information indicating the type of the Trigger frame. Here, information indicating that the frame is the “Coordination Trigger frame” is included.

The Trigger Dependent Common Info includes fields of Coordination Type, Coordination SN, and Joint Tx Packet Info as an individual information group for each type of the Trigger frame.

The Coordination Type includes information indicating a candidate for the coordinated transmission scheme. For example, in a case where there are the Coordinated Tx and Joint Tx as the coordinated transmission scheme, it is possible to provide a two-bit field as the Coordination Type, and “00” can be set to “None”, “01” can be set to “Coordinated Tx”, “10” can be set to “Joint Tx”. Alternatively, notification may be provided by another method such as providing one bit of each of “Coordinated Tx Enabler flag” and “Joint Tx Enabler flag”. Note that, not only the Coordinated Tx and Joint Tx but also other coordinated transmission schemes may be included to be set.

Coordination Sequence Number (SN) includes information indicating a processing number of the coordinated transmission. The sequence number designated first is designated in the Coordination SN.

The Joint Tx Packet Info includes packet information regarding a packet that should be transmitted when performing the Joint Tx. For example, the packet information includes an information group in which at least the identification information of the wireless terminal STA to be the destination, TID, access category, and management number of the packet (for example, the sequence number) are associated with one another. Note that, in a case where the coordinated transmission scheme other than the Joint Tx is designated, the field may be skipped, filled with a bit, which is “0”, or another information type may be stored.

The User Info includes an AP ID including the identification information of the access point AP for which the frame is acquired as an individual information group notification of which is provided to a plurality of receivers. For example, as the identification information, a MAC address, BSS Color, and some other information capable of identifying the access point AP can be used.

Note that, the Coordination Trigger frame may have another configuration in addition to the frame configuration illustrated in FIG. 10 as long as at least the Coordination Type and Coordination SN are included. Furthermore, although the frame is supposed to be the MAC Frame, this may be transmitted as a TCP/IP Frame as long as the above-described information is included.

Thereafter, in the Coordination Tx Phase (S3 in FIG. 4), the access point AP1 and the access point AP2 start data transmission by coordinated transmission such as the Joint Tx (S16 and S17 in FIG. 4). In the wireless terminal STA, the data transmitted by the coordinated transmission such as the Joint Tx from the access point AP1 and the access point AP2 is received, and Ack is transmitted as a reception response thereto (S18 and S19 in FIG. 4). The access point AP1 and the access point AP2 receive the Ack from the wireless terminal STA, and finish a series of processing.

### First Processing Example: Master AP=Sharing AP

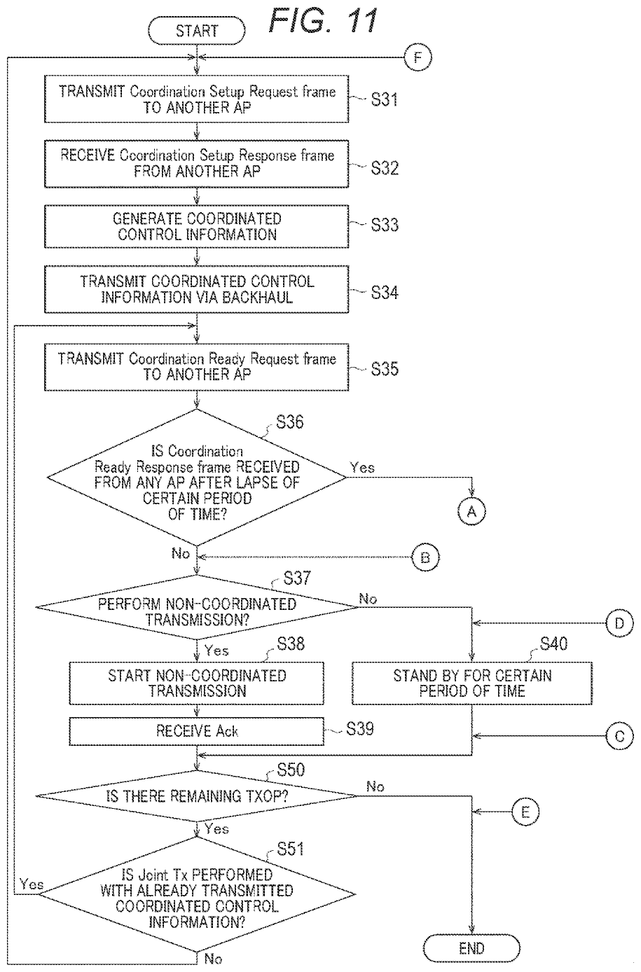

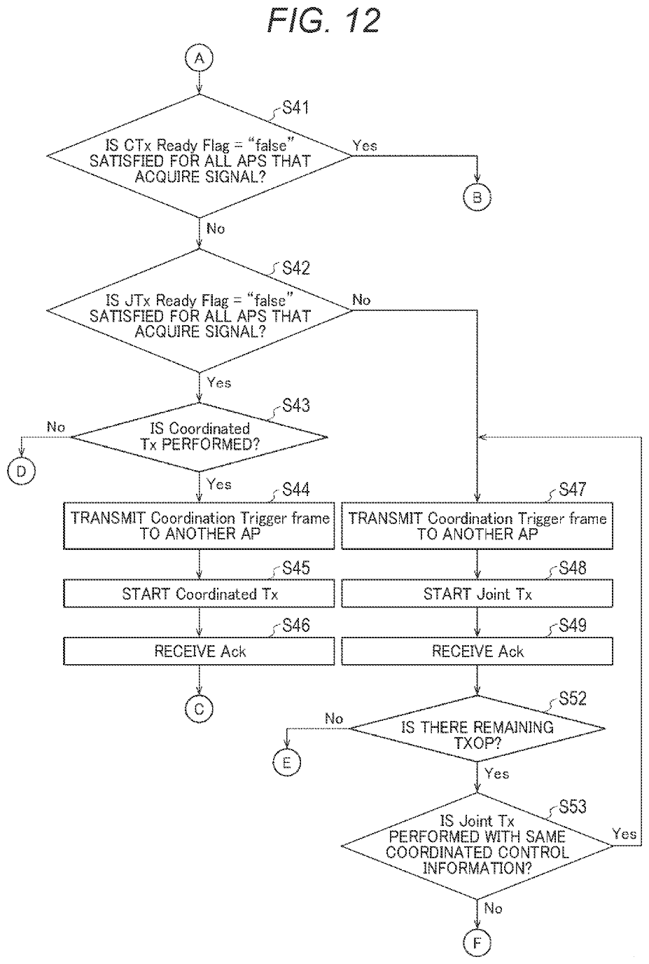

A flow of processing when the Master AP becomes a Sharing AP will be described with reference to flowcharts in FIGS. 11 and 12. Hereinafter, an access point AP that acquires a transmission right and starts the coordinated transmission is referred to as the Sharing AP, and an access point AP that does not acquire the transmission right but receives a request and performs the coordinated transmission is referred to as a Shared AP.

First, the Master AP generates the Coordination Setup Request frame and transmits the same to another access point AP that serves as the coordination candidate (S31), and receives the Coordination Setup Response frame from the other access point AP (S32).

Thereafter, the Master AP generates the coordinated control information including the schedule information and transmission weight information for performing the Joint Tx on the basis of the information acquired from the received Coordination Setup Response frame (S33), and transmits the same to another access point AP requested to perform the coordinated transmission via the backhaul (S34).

The Master AP generates the Coordination Ready Request frame and transmits the same to the other access point AP (S35), and after a lapse of a certain period of time, performs next processing on the basis of a reception status of the Coordination Ready Response frame and the acquired contents. Note that, the certain period of time is a time according to the time information designated in the Response Time Info field of the Coordination Ready Request frame (FIG. 8).

That is, in a case where the Master AP cannot receive the Coordination Ready Response frame from any of the access points APs (“No” at S36), or in a case where CTx Ready Flag=“false” is satisfied for all the access points APs that acquire the signal (“Yes” at S41), the processing proceeds to step S37.

In these cases, the Master AP determines whether or not to perform non-coordinated transmission (S37). The non-coordinated transmission is a transmission scheme in which the Master AP performs the data transmission alone. In a case of performing the non-coordinated transmission (“Yes” at S37), the Master AP starts the data transmission to the wireless terminal STA according to the current transmission scheme (S38), and receives Ack as a reception response thereto (S39). In contrast, in a case where the non-coordinated transmission is not performed (“No” at S37), the Master AP stands by for a certain period of time (S40). When processing at step S39 or S40 is finished, the processing proceeds to step S50.

Here, as a criterion for the Master AP to determine whether to perform the non-coordinated transmission or not, for example, it can be determined that the non-coordinated transmission is performed in a case where any one of following conditions (a1) to (a3) is satisfied. These determination criteria are used to suppress a situation in which a packet scheduled to be transmitted when performing the subsequent Joint Tx is transmitted first and no packet to be transmitted remains when performing the Joint Tx.
(a1) When the Joint Tx that uses the same coordinated control information as that being currently transmitted (or already transmitted) in the same TXOP is not performed in the future,
(a2) when a packet addressed to a wireless terminal STA other than the wireless terminal STA designated in the schedule information being currently transmitted (or already transmitted) is stored (held), and
(a3) when a packet other than the designated packet is stored (held) in the wireless terminal STA designated in the schedule information being currently transmitted (or transmitted).

That is, in a case where the packet to be transmitted to the wireless terminal STA is stored in the storage unit 102 or the communication storage unit 112, the Master AP can select the transmission scheme including the non-coordinated transmission on the basis of the packet information regarding the packet stored in the same and the packet stored in another access point AP.

Next, in a case where at least one access point AP out of all the access points APs that acquire the signal satisfies CTx Ready Flag=“true”, and JTx Ready Flag=“false” is satisfied for all the access points APs that acquire the signal, (“No” at S41 and “Yes” at S42), the processing proceeds to step S43.

In this case, the Master AP determines whether or not to perform the data transmission by the Coordinated Tx (S43). In a case where the data transmission by the Coordinated Tx is performed (“Yes” at S43), the Master AP generates the Coordination Trigger frame and transmits the same to another corresponding access point AP (S44). Thereafter, the Master AP starts the data transmission to the wireless terminal STA by the Coordinated Tx (S45), and receives Ack as a reception response thereto (S46). When the processing at step S46 is finished, the processing proceeds to step S50. In contrast, in a case where the data transmission by the Coordinated Tx is not performed, the Master AP stands by for a certain period of time (S40).

Here, as a criterion for the Master AP to determine whether to perform the data transmission by the Coordinated Tx or not, for example, it can be determined that the data transmission is performed by the Coordinated Tx in a case where any one of following conditions (b1) to (b3) is satisfied. These determination criteria are used to suppress a situation in which a packet scheduled to be transmitted when performing the subsequent Joint Tx is transmitted first and no packet to be transmitted remains when performing the Joint Tx.
(b1) When the Joint Tx that uses the same coordinated control information as that being currently transmitted (or already transmitted) in the same TXOP is not performed in the future,
(b2) when a packet addressed to a wireless terminal STA other than the wireless terminal STA designated in the schedule information being currently transmitted (or already transmitted) is stored (held), and
(b3) when a packet other than the designated packet is stored (held) in the wireless terminal STA designated in the schedule information being currently transmitted (or transmitted).

That is, in a case where the packet to be transmitted to the wireless terminal STA is stored in the storage unit 102 or the communication storage unit 112, the Master AP can select the transmission scheme including the coordinated transmission such as the Coordinated Tx on the basis of the packet information regarding the packet stored in the same and the packet stored in another access point AP.

Next, in a case where at least one access point AP out of all the access points APs that acquire the signal satisfies JTx Ready Flag=“true” (“No” at S42), the processing proceeds to step S47.

In this case, the Master AP generates the Coordination Trigger frame and transmits the same to another corresponding access point AP (S47). Thereafter, the Master AP starts the data transmission to the wireless terminal STA by the Joint Tx (S48), and receives Ack as a reception response thereto (S49). When the processing at step S49 is finished, the processing proceeds to step S52.

In a case where it is determined that there is no remaining time of the TXOP after any processing described above is finished (“No” at S50 and “No” at S52), the Master AP finishes a series of processing. In contrast, in a case where there is a margin in the remaining time of the TXOP (“Yes” at S50 and “Yes” at S52), the Master AP performs next processing when attempting to perform the data transmission again.

That is, in a case where the previous processing is other than the transmission by the Joint Tx, the Master AP determines whether or not to attempt to perform the Joint Tx using (the schedule information and transmission weight information included in) the coordinated control information currently being transmitted (or already transmitted) via the backhaul (S51). In a case where the Master AP attempts to perform the Joint Tx using the same coordinated control information (“Yes” at S51), this transmits the Coordination Ready Request to another access point AP again (S35), and similarly performs the subsequent processing. In contrast, in a case where the Master AP does not attempt to perform the Joint Tx using the same coordinated control information (“No” at S51), this transmits the Coordination Setup Request frame to another access point AP again (S31), and similarly performs the subsequent processing.

Furthermore, in a case where the previous processing is the Joint Tx, the Master AP determines whether or not to attempt to perform the Joint Tx using (the schedule information and transmission weight information included in) the same coordinated control information (S53). In a case where the Master AP attempts to perform the Joint Tx using the same coordinated control information (“Yes” at S53), this transmits the Coordination Trigger frame to another access point AP again (S47), and similarly performs the subsequent processing. In contrast, in a case where the Master AP does not attempt to perform the Joint Tx using the same coordinated control information (“No” at S53), this transmits the Coordination Setup Request frame to another access point AP again (S31), and similarly performs the subsequent processing.

Note that, in a case where the Joint Tx using new coordinated control information is performed again, the Coordination SN in the frame is set to a new sequence number, and the transmission is performed. Otherwise, in the transmitted frame, the same sequence number is stored in the Coordination SN in all the frames. Note that, when it is determined at steps S51 and S53 that the Joint Tx is not performed, the Master AP may start the non-coordinated transmission from the beginning without transmitting the Coordination Setup Request frame.

### Second Processing Example: Non-Master AP=Shared AP

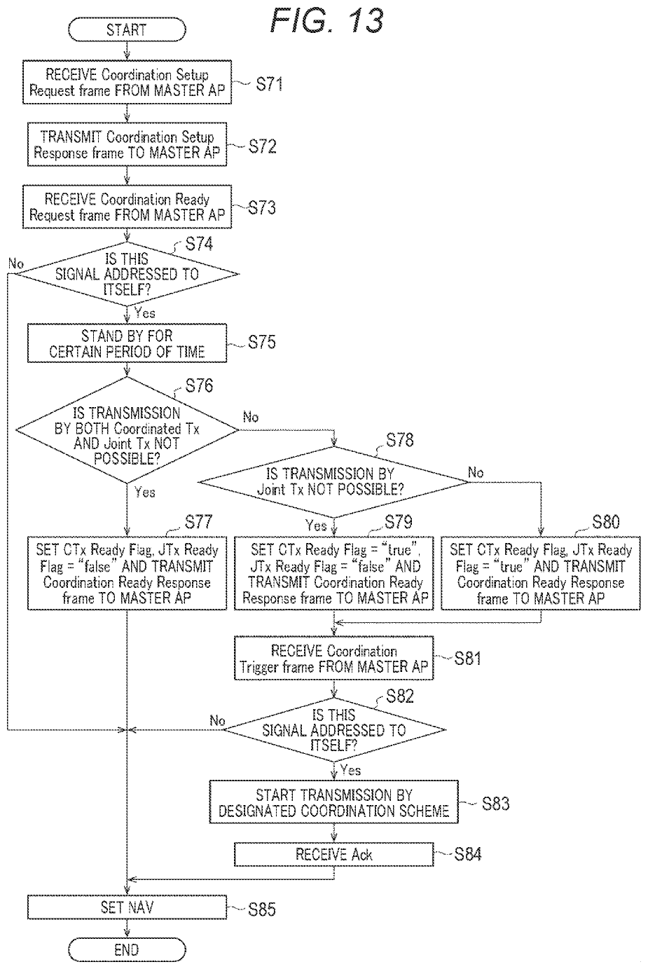

Next, a flow of processing when the non-Master AP becomes the Shared AP will be described with reference to a flowchart in FIG. 13.

First, the non-Master AP receives the Coordination Setup Request frame from the Master AP (S71), and generates the Coordination Setup Response frame as a response thereto to transmit (S72). Note that, this frame exchange may be skipped according to a processing status of the Master AP.

Thereafter, the non-Master AP receives the Coordination Ready Request frame from the Master AP (S73), and in a case where this is a signal addressed to the non-Master AP itself (“Yes” at S74), this performs next processing on the basis of the acquisition status of the coordinated control information transmitted via the backhaul after a lapse of a certain period of time (S75). Note that, the certain period of time is a time according to the time information designated in the Response Time Info field of the Coordination Ready Request frame (FIG. 8).

That is, in a case where the non-Master AP determines that the non-Master AP itself cannot transmit by both the Coordinated Tx and Joint Tx (“Yes” at S76), this sets CTx Ready Flag=“false” and JTx Ready Flag=“false, generates the Coordination Ready Response frame, and transmits the same to the Master AP (S77).

Here, as a criterion for the non-Master AP to determine that it is not possible to transmit by both the Coordinated Tx and Joint Tx, for example, it can be determined that it is not possible to transmit by both the Coordinated Tx and Joint Tx in a case where a following condition (c1) or (c2) is satisfied.
(c1) When schedule information is not acquired from the Master AP, and
(c2) when only the schedule information is acquired from the Master AP (transmission weight information cannot be acquired), but the packet to be transmitted other than the packet of the wireless terminal STA designated in the schedule information is not stored (held).

That is, in a case where the packet to be transmitted to the wireless terminal STA is stored in the storage unit 102 or the communication storage unit 112, the non-Master AP can select the transmission scheme including the coordinated transmission such as the Coordinated Tx and Joint Tx on the basis of the packet information regarding the packet stored in the non-Master AP itself.

Next, in a case where the non-Master AP determines that the non-Master AP itself can transmit by the Coordinated Tx but cannot transmit by the Joint Tx (“Yes” at S78), this sets CTx Ready Flag=“true” and JTx Ready Flag=“false, generates the Coordination Ready Response frame, and transmits the same to the Master AP (S79). In contrast, in a case where the non-Master AP determines that the non-Master AP itself can transmit by both the Coordinated Tx and Joint Tx (“No” at S78), this sets CTx Ready Flag=“true”, and JTx Ready Flag=“true”, generates the Coordination Ready Response frame, and transmits the same to the Master AP (S80).

Here, as a criterion for the non-Master AP to determine that the Joint Tx can be performed, for example, it can be determined that the transmission by the Joint Tx is possible in a case where a following condition (d1) is satisfied.
(d1) When both the schedule information and transmission weight information are already acquired from the Master AP.

Thereafter, the non-Master AP receives the Coordination Trigger frame from the Master AP (S81), and in a case of the signal addressed to the non-Master AP itself (“Yes” at S82), this starts the coordinated transmission according to (a candidate for) the coordinated transmission scheme designated in the Coordination Type designated in the Coordination Trigger frame (FIG. 10) (S83), and receives Ack as a reception response thereto (S84).

In a case where it is determined in the processing at step S74 or S82 that this is not the signal addressed to the non-Master AP itself (“No” at S74 and “No” at S82), or in a case where the processing at step S77 or S84 is finished, the processing proceeds to step S85. That is, in any processing, a network allocation vector (NAV) is finally set (or the already set NAV is updated) (S85), and a series of processing is finished.

### Third Processing Example: Non-Master AP=Sharing AP

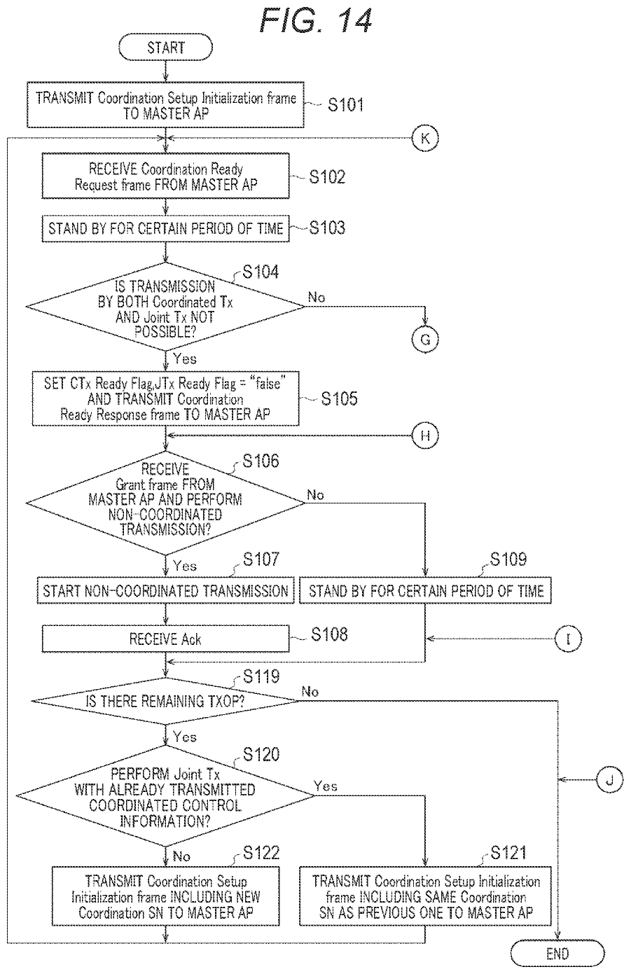

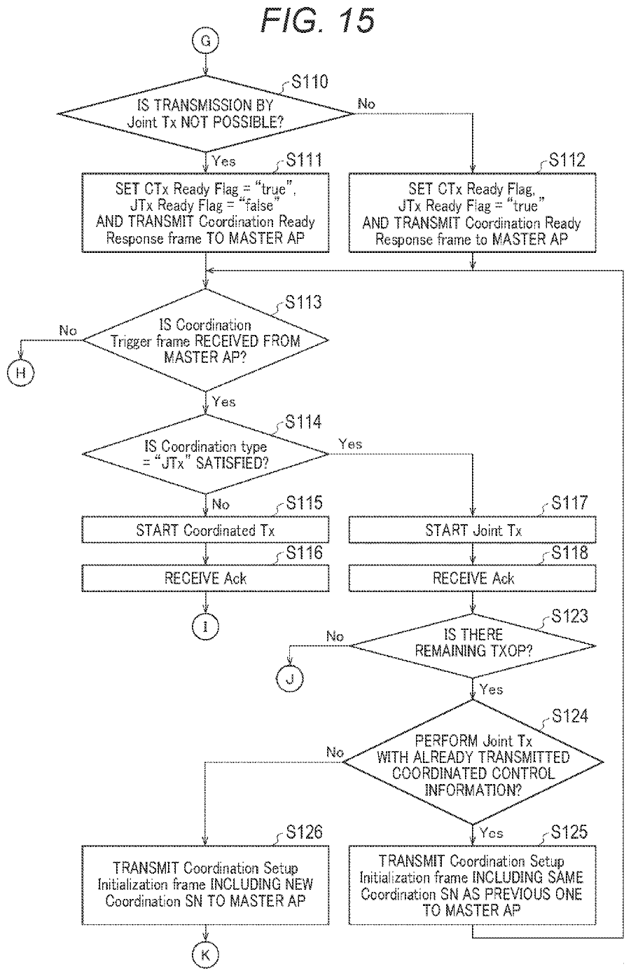

Next, a flow of processing when the non-Master AP becomes the Sharing AP will be described with reference to flowcharts in FIGS. 14 and 15.

The non-Master AP generates the Coordination Setup Initialization frame and transmits the same to the Master AP (S101). Thereafter, there is a possibility that the Coordination Request frame is transmitted from the Master AP to the non-Master AP; however, if the Master AP is already notified of required information by the Coordination Setup Initialization frame, it is not especially required to acquire the Coordination Request frame to respond.

Next, the non-Master AP receives the Coordination Ready Request frame from the Master AP (S102), and performs next processing on the basis of the acquisition status of the coordinated control information transmitted via the backhaul after a lapse of a certain period of time (S103). Note that, the certain period of time is a time according to the time information designated in the Response Time Info field of the Coordination Ready Request frame (FIG. 8).

That is, in a case where the non-Master AP determines that the non-Master AP itself cannot transmit by both the Coordinated Tx and Joint Tx (“Yes” at S104), this sets CTx Ready Flag=“false” and JTx Ready Flag=“false”, generates the Coordination Ready Response frame, and transmits the same to the Master AP (S105).

Thereafter, the non-Master AP receives a Grant frame from the Master AP, and in a case where the non-coordinated transmission is performed (“Yes” at S106), this starts the data transmission to the wireless terminal STA according to the current transmission scheme (S107), and receives Ack as a reception response thereto (S108). In contrast, in a case where the non-coordinated transmission is not performed (“No” at S106), the non-Master AP stands by for a certain period of time (S109).

Here, the criterion for the non-Master AP to determine that it is not possible to transmit by both the Coordinated Tx and Joint Tx, and the criterion to determine whether to perform the non-coordinated transmission or not are as described above, so that they are not repeatedly described; for example the above-described condition (c1) or (c2) can be used.

Next, in a case where the non-Master AP determines that the non-Master AP itself can transmit by the Coordinated Tx but cannot transmit by the Joint Tx (“Yes” at S110), this sets CTx Ready Flag=“true” and JTx Ready Flag=“false”, generates the Coordination Ready Response frame, and transmits the same to the Master AP (S111). In contrast, in a case where the non-Master AP determines that the non-Master AP itself can transmit by both the Coordinated Tx and Joint Tx (“No” at S110), this sets CTx Ready Flag=“true”, and JTx Ready Flag=“true”, generates the Coordination Ready Response frame, and transmits the same to the non-Master AP (S112).

Here, the criterion for the non-Master AP to determine that it is possible to transmit by the Joint Tx is as described above, so that this is not repeatedly described; for example, the condition (d1) described above can be used.

Thereafter, in a case where the non-Master AP receives the Coordination Trigger frame from the Master AP (“Yes” at S113), this starts the coordinated transmission according to (a candidate for) the coordinated transmission scheme designated in the Coordination Type designated in the Coordination Trigger frame (FIG. 10).

That is, in a case where Coordination Type=“Joint Tx (JTx)” is not satisfied (“No” at S114), the non-Master AP starts the data transmission to the wireless terminal STA by the Coordinated Tx (S115), and receives Ack as a reception response thereto (S116). When the processing at step S116 is finished, the processing proceeds to step S119.

In contrast, in a case where Coordination Type=“Joint Tx (JTx)” is satisfied (“Yes” at S114), the non-Master AP starts the data transmission to the wireless terminal STA by the Joint Tx (S117), and receives Ack as a reception response thereto (S118). When the processing at step S118 is finished, the processing proceeds to step S123.

In a case where it is determined that there is no remaining time of the TXOP after any processing described above is finished (“No” at S119 and “No” at S123), the non-Master AP finishes a series of processing. In contrast, in a case where there is a margin in the remaining time of the TXOP (“Yes” at S119 and “Yes” at S123), the non-Master AP performs next processing when attempting to perform the data transmission again.

That is, in a case where the previous processing is other than the transmission by the Joint Tx, the non-Master AP determines whether or not to attempt to perform the Joint Tx using (the schedule information and transmission weight information included in) the coordinated control information currently being transmitted (or already transmitted) via the backhaul (S120).

In a case where the non-Master AP attempts to perform the Joint Tx using the same coordinated control information (“Yes” at S120), the non-Master AP generates the Coordination Setup Initialization frame including the same Coordination SN as the previous time, transmits the same again to the Master AP (S121), and stands by for the Coordination Ready Request frame to be transmitted from the Master AP again (S102). In contrast, in a case where the non-Master AP does not attempt to perform the Joint Tx using the same coordinated control information (“No” at S120), this generates the Coordination Setup Initialization frame including a new Coordination SN, transmits the same to the Master AP again (S122), and stands by for the Coordination Ready Request frame to be transmitted from the Master AP again (S102).

Furthermore, in a case where the previous processing is the Joint Tx, the non-Master AP determines whether or not to attempt to perform the Joint Tx using the same schedule information and transmission weight information (S124).

In a case where the non-Master AP attempts to perform the Joint Tx using the same coordinated control information (“Yes” at S124), this generates the Coordination Setup Initialization frame including the same Coordination SN as the previous time, transmits the same again to the Master AP (S125), and stands by for the Coordination Trigger frame to be transmitted from the Master AP again (S113). In contrast, in a case where the non-Master AP does not attempt to perform the Joint Tx using the same coordinated control information (“No” at S124), this generates the Coordination Setup Initialization frame including the new Coordination SN, transmits the same to the Master AP again (S126), and stands by for the Coordination Ready Request frame to be transmitted from the Master AP again (S102). Note that, when it is determined at steps S120 and S124 that the Joint Tx is not performed, the Master AP may start the non-coordinated transmission from the beginning without transmitting the Coordination Setup Request frame.

### Fourth Processing Example: Master AP=Shared AP

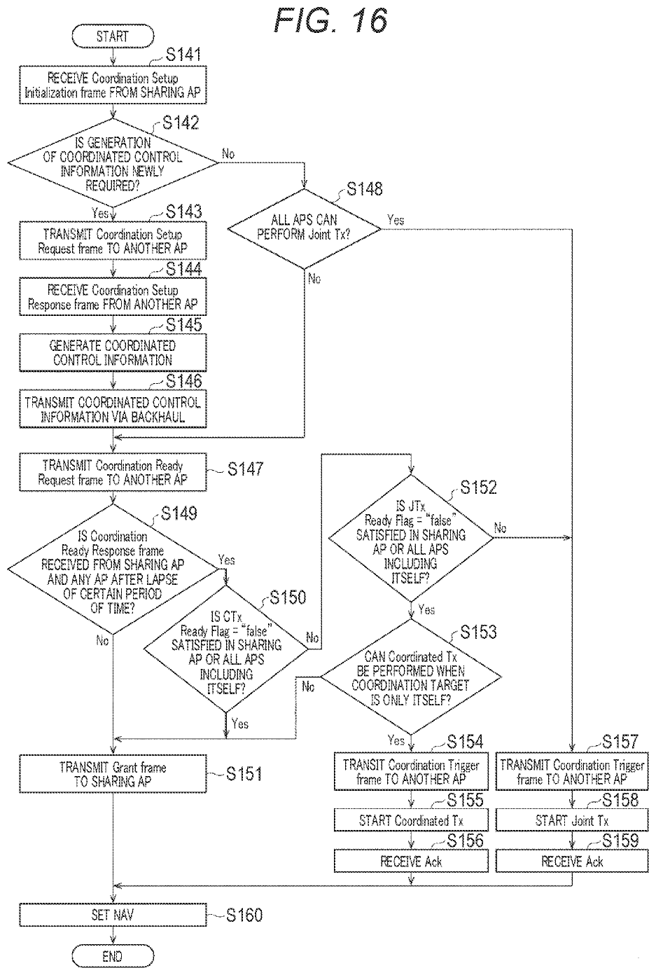

Next, a flow of processing when the Master AP becomes the Shared AP will be described with reference to a flowchart in FIG. 16.

First, the Master AP receives the Coordination Setup Initialization frame from the non-Master AP as the Sharing AP (S141), and determines whether or not the coordinated control information is required to be newly generated with reference to the Coordination Type and Coordination SN in the frame (S142).

In a case where the Master AP determines that the coordinated control information is required to be newly generated (“Yes” at S142), this generates the Coordination Setup Request frame and transmits the same to another access point AP (except for the Sharing AP) that serves as the coordination candidate (S143), and receives the Coordination Setup Response frame from the other access point AP (S144).

Thereafter, the Master AP generates the coordinated control information including the schedule information and transmission weight information for performing the Joint Tx on the basis of the information acquired from the Coordination Setup Response frame (S145), and transmits the same to another access point AP (including the Sharing AP) actually requested to perform the coordinated transmission via the backhaul (S146). Then, the Master AP generates the Coordination Ready Request frame and transmits the same to another access point AP (S147).

In contrast, in a case where it is determined that it is not required to newly generate the coordinated control information (“No” at S142), in a case where the Master AP recognizes that all the access points APs that are the coordination candidates are in the state in which the Joint Tx can be performed in the existing coordinated control information (“Yes” at S148), the processing proceeds to step S157 to shift to Joint Tx performing processing. The Joint Tx performing processing will be described later in detail. Furthermore, in a case where some of the access points APs are not yet in the state in which the Joint Tx can be performed, the Coordination Ready Request frame is transmitted to at least the corresponding access point AP (S147).

Thereafter, after a lapse of a certain period of time, the Master AP performs next processing on the basis of the reception status of the Coordination Ready Response frame and the acquired contents. Note that, the certain period of time is a time according to the time information designated in the Response Time Info field of the Coordination Ready Request frame (FIG. 8).

That is, in a case where the Master AP cannot receive the Coordination Ready Response frame from the Sharing AP and any access point AP other than the Sharing AP (“No” at S149), this generates the Grant frame and transmits the same to the Sharing AP (S151). Alternatively, in a case where CTx Ready Flag=“false” is satisfied (“Yes” at S150) in the Sharing AP or all the access points APs of the coordination candidates other than the Sharing AP including itself from the acquired signal, the Grant frame is transmitted to the Sharing AP (S151). When the Master AP as the Shared AP transmits the Grant frame, the non-coordinated transmission of the Sharing AP is allowed.

Next, in a case where CTx Ready Flag=“true” is satisfied in the Sharing AP and at least one access point AP (“No” at S150), when JTx Ready Flag=“false” is satisfied in the Sharing AP or all the access points APs that are the coordination candidates other than the Sharing AP including the Master AP itself (“Yes” at S152), the Master AP determines whether or not the Coordinated Tx can be performed only by the Master AP itself as the coordination target that performs the coordinated transmission with the Sharing AP (S153).

In a case where the Coordinated Tx can be performed (“Yes” at S153) only by the Master AP itself as the coordination target that performs the coordinated transmission with the Sharing AP, the Master AP generates the Coordination Trigger frame and transmits the same to another corresponding access point AP requested to perform the coordination transmission with the Sharing AP (S154). Then, the Master AP starts the data transmission to the wireless terminal STA by the Coordinated Tx (S155) only in a case where the Master AP is the target of the coordinated transmission, and receives Ack as a reception response thereto (S156).

However, in a case where the Master AP determines that the Master AP itself is the only coordination target that performs the coordinated transmission with the Sharing AP and the Master AP itself cannot perform the Coordinated Tx according to the above-described criterion (“No” at S153), this transmits the Grant frame to the Sharing AP (S151), and allows the data transmission (non-coordinated transmission) by the Sharing AP alone.

Next, in a case where JTx Ready Flag=“true” is satisfied in the Sharing AP and at least one access point AP (“No” at S152), the Master AP generates the Coordination Trigger frame and transmits the same to another corresponding access point AP (S157). Then, the Master AP starts the data transmission to the wireless terminal STA by the Joint Tx only in a case where the Master AP itself is the target of the coordinated target (S158), and receives Ack as a reception response thereto (S159).

When the processing at step S151, S156, or S159 is finished, the processing proceeds to step S160. That is, in any processing, NAV is finally set (S160), and a series of processing is finished.

Note that, in the description of the flowcharts so far, the selection of the coordinated transmission scheme by exchanging the Coordination Ready Request frame and the Coordination Ready Response frame is mainly described, but it is not actually limited thereto.

For example, the wireless terminal STA from which sufficient feedback cannot be acquired in the Sounding Phase (S2 in FIG. 4) may be excluded from the candidates for the Joint Tx. Furthermore, in a case where a sufficient transmission time cannot be secured even if the TXOP remains, it is possible that the coordinated transmission is not performed from the beginning in the second and subsequent data transmission, and perform the data transmission alone according to the current scheme. Moreover, upper link (UL) communication may be induced at the time of transmission by one access point AP. Furthermore, in a case where the time designated by the Expiration Time Info in the Coordination Ready Request frame elapses from the time when the coordinated control information is acquired, new coordinated control information may be generated (or requested to be generated).

### Fifth Processing Example: STA

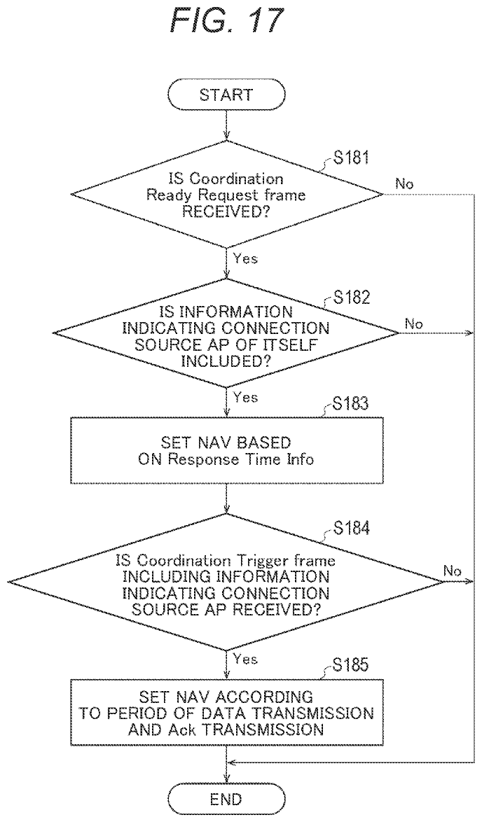

Next, a flow of processing by the wireless terminal STA is described with reference to a flowchart in FIG. 17.

Here, NAV setting when a frame exchanged between the access points APs is received will be mainly described. Note that, the NAV setting herein includes not only setting of an existing NAV but also updating. Furthermore, no matter which frame is received, processing of performing the NAV setting based on L Length information included in Preamble is essential, so that the description thereof is omitted in this flowchart.

First, in a case where the wireless terminal STA receives the Coordination Ready Request frame transmitted from a communication device of another BSS (overlapping basic service set (OBSS)) (“Yes” at S181), when information indicating the access point AP of its own connection source is included in the frame (“Yes” at S182), the wireless terminal STA sets NAV as a transmission suppression period on the basis of Response Time Info in a field that is Common Info (S183).

This is because the data transmission from the wireless terminal STA belonging to the same BSS is suppressed until the access point AP of the connection source responds to the Coordination Ready Response frame. Thereafter, in a case where the wireless terminal STA receives the Coordination Trigger frame including the information indicating the access point AP of its own connection source (“Yes” at S184), this sets the NAV as the transmission suppression period according to the periods of the data transmission and Ack transmission on the basis of the information included in the frame (S185).

Note that, in a case where it is determined as No at steps S181, S182, and S184, subsequent processing is skipped, and a series of processing is finished.

(Effects of Present Technology)

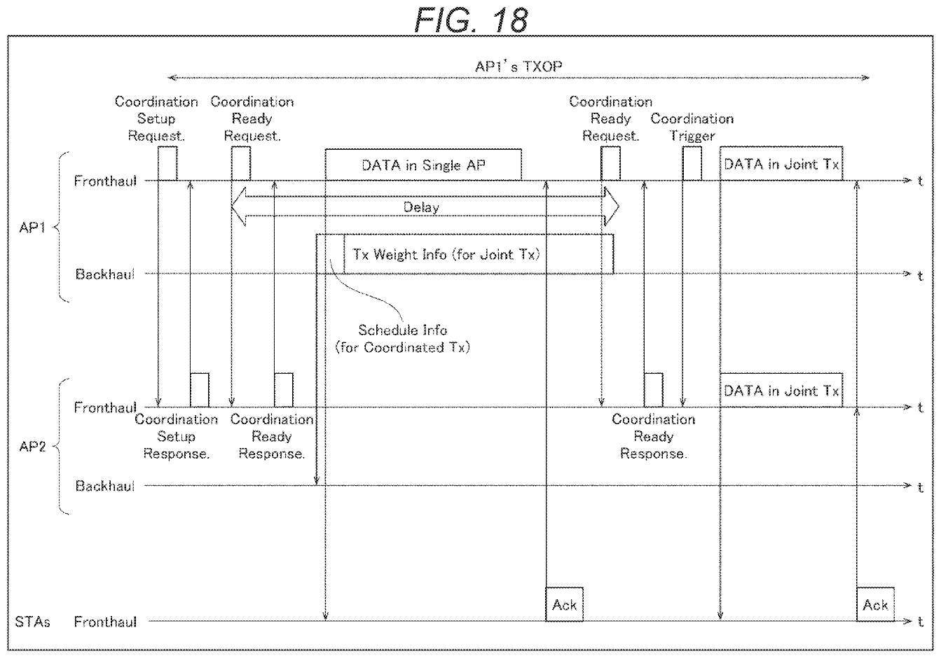

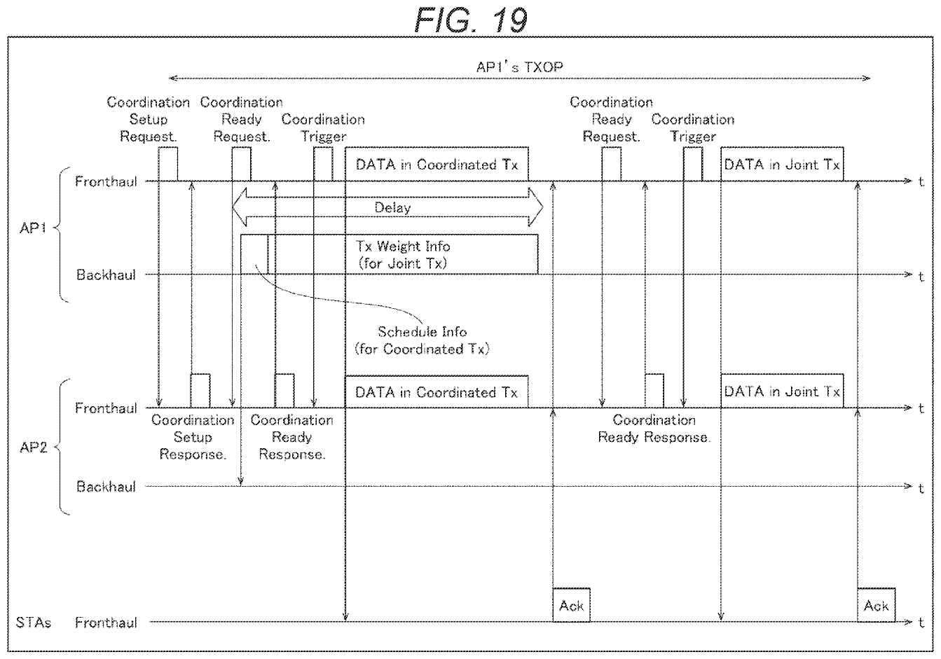

An effect obtained by the coordinated transmission to which the present technology is applied will be described with reference to FIGS. 18 and 19.

FIG. 18 is a diagram illustrating a first operation example of the coordinated transmission to which the present technology is applied. In FIGS. 18, as in FIG. 3, signal exchange between the respective devices in the fronthaul and backhaul is represented in time series.

In the coordinated transmission of the current scheme, a delay occurs during the coordinated control information transmission via the backhaul, and the access point AP1 is required to stand by until the information reaches the access point AP2 as described with reference to FIG. 3.

In contrast, in the coordinated transmission to which the present technology is applied, the Coordination Ready Request frame and the Coordination Ready Response frame are exchanged between the access point AP1 and the access point AP2 (frame exchange).

In FIG. 18, at the time of first frame exchange, the access point AP1 recognizes that the access point AP2 cannot acquire either the schedule information or transmission weight information, and in initial transmission, only the access point AP1 can perform the non-coordinated transmission to a subordinate wireless terminal STA (“DATA in Single AP” in the drawing).

Subsequently, at the time of second frame exchange, the access point AP1 recognizes that the access point AP2 can acquire both the schedule information and transmission weight information, and in next transmission, the access point AP1 and the access point AP2 can perform the coordinated transmission by the Joint Tx to a subordinate wireless terminal STA (“DATA in Joint Tx” in the drawing).

FIG. 19 is a diagram illustrating a second operation example of the coordinated transmission to which the present technology is applied. In FIGS. 19, as in FIGS. 3 and 18, signal exchange between the respective devices in the fronthaul and backhaul is represented in time series.

In FIG. 19, at the time of first frame exchange, the access point AP1 recognizes that the access point AP2 can acquire only the schedule information, and in initial transmission, the access point AP1 and the access point AP2 can perform the coordinated transmission by the Coordinated Tx to a subordinate wireless terminal STA (“DATA in Coordinated Tx” in the drawing).

Subsequently, at the time of second frame exchange, the access point AP1 recognizes that the access point AP2 can acquire both the schedule information and transmission weight information, and in next transmission, the access point AP1 and the access point AP2 can perform the coordinated transmission by the Joint Tx to a subordinate wireless terminal STA (“DATA in Joint Tx” in the drawing).

As described above, in both the first operation example and second operation example of the coordinated transmission to which the present technology is applied, even in a case where an unexpected delay occurs on the backhaul side, the access point AP1 can check the status of the access point AP2 that is the coordination candidate and efficiently select the transmission scheme without wasting time.

### 2. Second Embodiment

The first embodiment is based on the premise that the data sharing between the access points APs is already completed when the coordinated transmission is performed, but in a second embodiment, a case will be described in which it is also required to share a packet storing data for coordinated transmission (data for coordination) between the access points APs.

In the second embodiment, there are two major differences from the first embodiment: first, the data for coordination is also transmitted from the Shared AP via the backhaul, and second, packet information that can be acquired by each access point AP is required for determining to perform the coordinated transmission scheme and determining scheduling. Hereinafter, in the description of the second embodiment, it is focused on differences from the first embodiment, and redundant description will be omitted as appropriate.

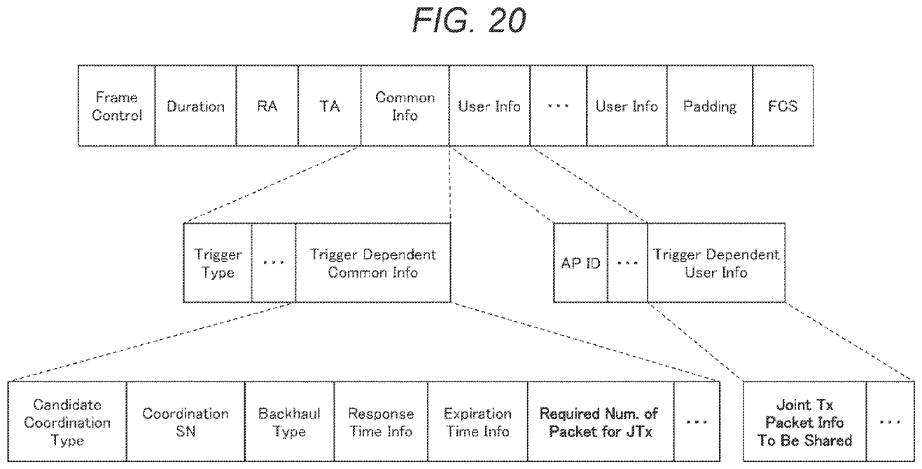

FIG. 20 is a diagram illustrating a configuration example of a Coordination Ready Request frame in the second embodiment.

In FIG. 20, the Coordination Ready Request frame is different from the configuration of the Coordination Ready Request frame in FIG. 8 in that a field of Required Num. of Packet for JTx is added in the Trigger Dependent Common Info field in the Common Info, and a field of Joint Tx Packet Info To Be Shared is newly added to the Trigger Dependent User Info field in the User Info.

The Required Num. of Packet for JTx includes information indicating the minimum number of packets for determining that the Joint Tx can be performed at the time of response. A numerical value can be calculated by a bit of the field, or a table in which the bit and the numerical value are associated with each other may be prepared in advance. Furthermore, the field may be set to provide notification that “the Joint Tx is not performed until all the packets are shared”.

The Joint Tx Packet Info To Be Shared includes packet information regarding a packet requested to be shared with another access point AP in order to perform the Joint Tx. For example, the packet information includes an information group and the like in which at least the identification information of the wireless terminal STA to be the destination, TID, access category, and management number of the packet (for example, the sequence number) are associated with one another. Note that, in a case where the coordinated transmission scheme other than the Joint Tx is designated, the field may be skipped, filled with a bit, which is “0”, or another information type may be stored.

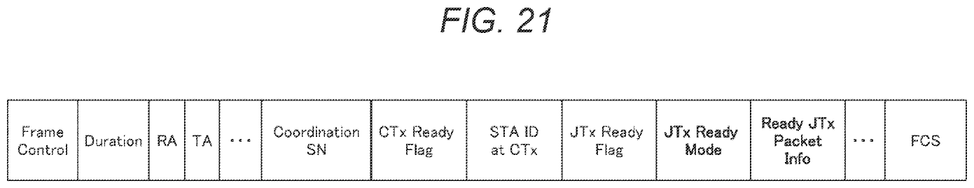

FIG. 21 is a diagram illustrating a configuration example of a Coordination Ready Response frame in the second embodiment.

In FIG. 21, the Coordination Ready Response frame is different from the Coordination Ready Response frame in FIG. 9 in that fields of JTx Ready Mode and Ready JTx Packet Info are newly added.

The JTx Ready Mode includes information indicating a holding status of the packet shared by each access point AP. For example, a two-bit field is provided as JTx Ready Mode to indicate whether a certain number of packets storing the data for coordination transmitted from the sharing AP can be acquired or not by the first one bit, and indicate whether a certain number of packets storing the data for coordination transmitted from that other than the Sharing AP can be acquired or not by the remaining one bit.

For example, each bit indicates “false” in a case of “0”, and indicates “true” in a case of “1”. Note that, in a case where the access point AP itself is a Sharing AP, the first bit of the two bits is always set to “1”. Furthermore, it is possible to determine “whether a certain number can be acquired or not” using information included in the Required Num. of Packet for JTx of the Coordination Ready Request frame (FIG. 20) of which notification is provided from the Master AP.

The Ready JTx Packet Info includes packet information regarding the packet shared by another access point AP to be acquired. For example, the packet information includes an information group and the like in which at least the identification information of the wireless terminal STA to be the destination, TID, access category, and management number of the packet (for example, the sequence number) are associated with one another. As the packet information, in place of the above-described information, notification of information indicating that all the packets are already acquired or information indicating that all the packets addressed to a specific wireless terminal STA are already acquired may be provided.

### Sixth Processing Example: Master AP=Sharing AP

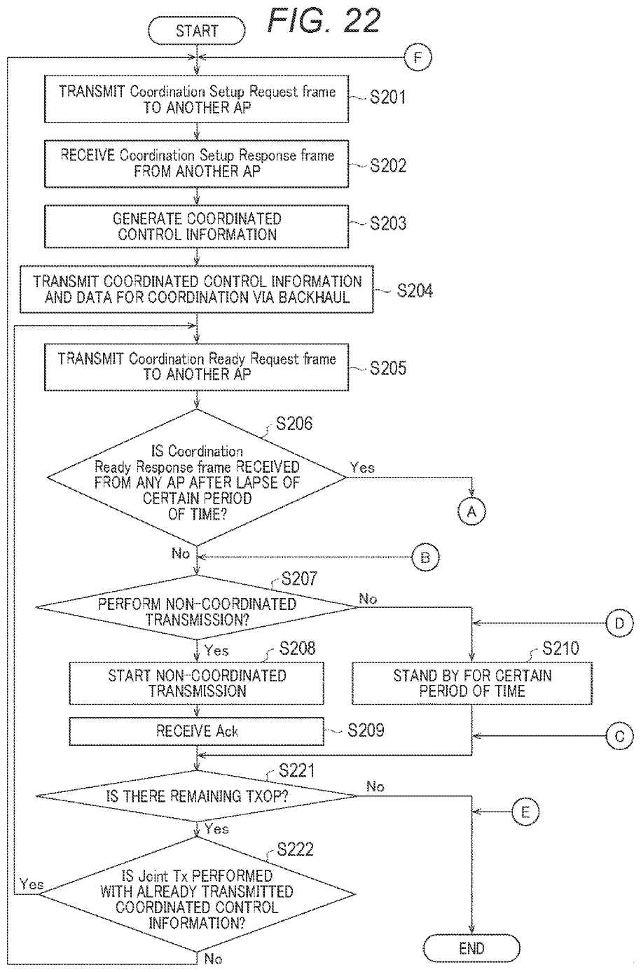

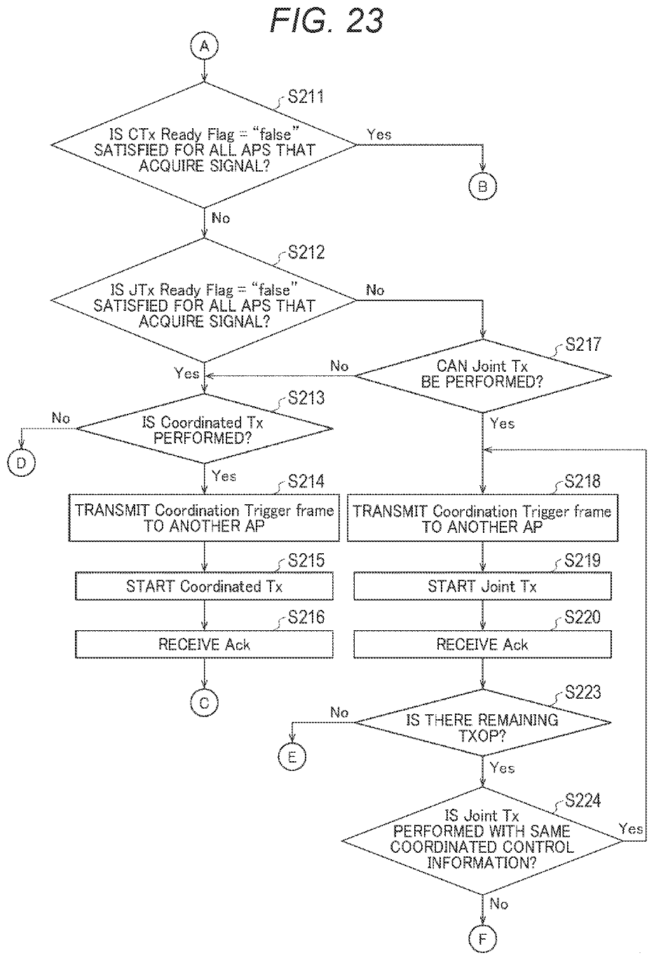

Next, a flow of processing when the Master AP becomes the Sharing AP in the second embodiment will be described with reference to flowcharts in FIGS. 22 and 23.

At steps S201 to S224 in FIGS. 22 and 23, processing when the Master AP becomes the Sharing AP is performed similarly to steps S31 to S53 in FIGS. 11 and 12, but it is different in that the processing at step S204 in FIG. 22 is performed in place of the processing at step S34 in FIG. 11, and the processing at step S217 in FIG. 23 is added.

At step S204 in FIG. 22, the Master AP transmits the coordinated control information to another access point AP requested to perform the coordinated transmission via the backhaul, and at the same time, transmits the data for coordination held by the Master AP itself together.

At step S217 in FIG. 23, the Master AP determines whether or not it is possible to acquire (the packet storing) the data for coordination transmitted by at least one access point AP of the corresponding access points APs and perform the Joint Tx.

That is, in a case where the packet storing the data for coordination sharing of which is requested by another access point AP is stored in the storage unit 102 or the communication storage unit 112, the Master AP can select the transmission scheme including the coordinated transmission such as the Joint Tx on the basis of the packet information regarding the packet stored in the Master AP itself and the packet stored in another access point AP.

The Master AP performs the Joint Tx performing processing for at least one access point AP only in a case where JTx Ready Flag=“true” is satisfied and the Joint Tx can be performed (“Yes” at S217) (S218 to S220).

Note that, at step S224, in a case where it is attempted to perform the Joint Tx by another data for coordination already shared using the same coordinated control information, it is possible to transmit the Coordination Trigger frame to another access point AP again (S218), and similarly perform the subsequent Joint Tx performing processing (S219 and S220).

### Seventh Processing Example: Non-Master AP=Shared AP

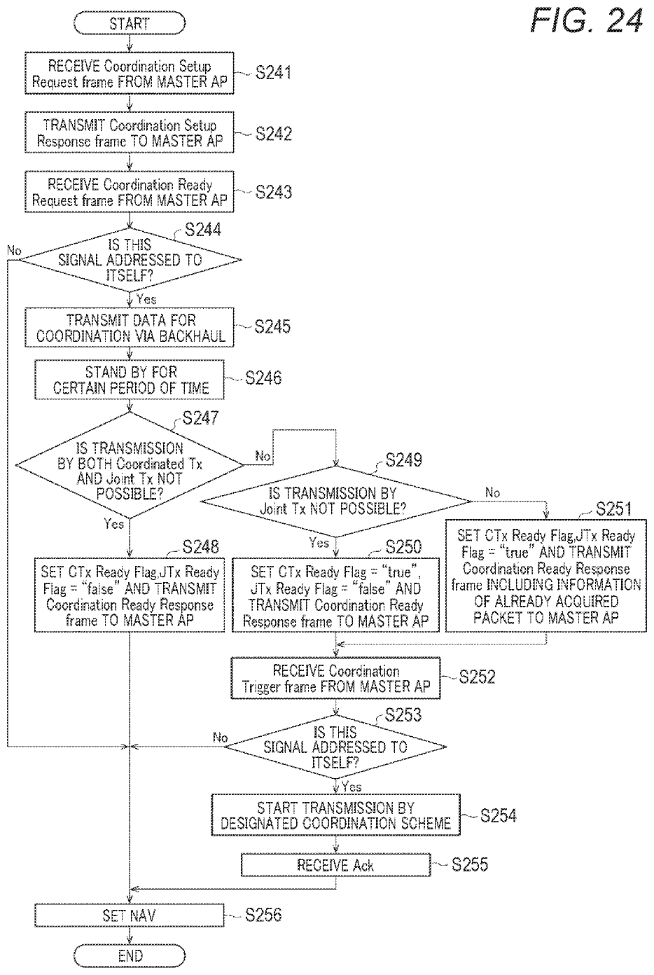

Next, a flow of processing when the non-Master AP becomes the Shared AP in the second embodiment will be described with reference to a flowchart in FIG. 24.

At steps S241 to S256 in FIG. 24, processing when the non-Master AP becomes the Shared AP is performed similarly to steps S71 to S85 in FIG. 13, but it is different in that the processing at step S245 in FIG. 24 is added and the processing at steps S249 and S251 in FIG. 24 is performed in place of the processing at step S78 and S80 in FIG. 13.

At step S245 in FIG. 24, after receiving the Coordination Ready Request frame (FIG. 20) addressed to the non-Master AP itself, the non-Master AP transmits (the packet storing) the data for coordination via the backhaul on the basis of the information (the packet information regarding the packet requested to be shared) included in the Joint Tx Packet Info To Be Shared of which notification is provided by the frame.

At step S249 in FIG. 24, as a criterion for the non-Master AP to determine that the Joint Tx can be performed, for example, it can be determined that the transmission by the Joint Tx is possible in a case where all following conditions (e1) and (e2) are satisfied.
(e1) When both the schedule information and transmission weight information are already acquired from the Master AP, and
(e2) when a part or all of (the packet storing) the data for coordination shared by the Sharing AP is already acquired.

However, in the condition (e2), a part of (the packet storing) the data for coordination is determined by a relationship (for example, a predetermined numerical value or more) with a value indicated by information included in the Required Num. of Packet for JTx of which notification is provided by the Coordination Ready Request frame.

At step S251 in FIG. 24, when generating the Coordination Ready Response frame (FIG. 21) to transmit to the Master AP, the non-Master AP includes, in addition to the flag information, an acquisition status of (the packet storing) the data for coordination and the packet information regarding (the packet storing) the acquired data for coordination in the Ready JTx Packet Info.

### Eighth Processing Example: Non-Master AP=Sharing AP

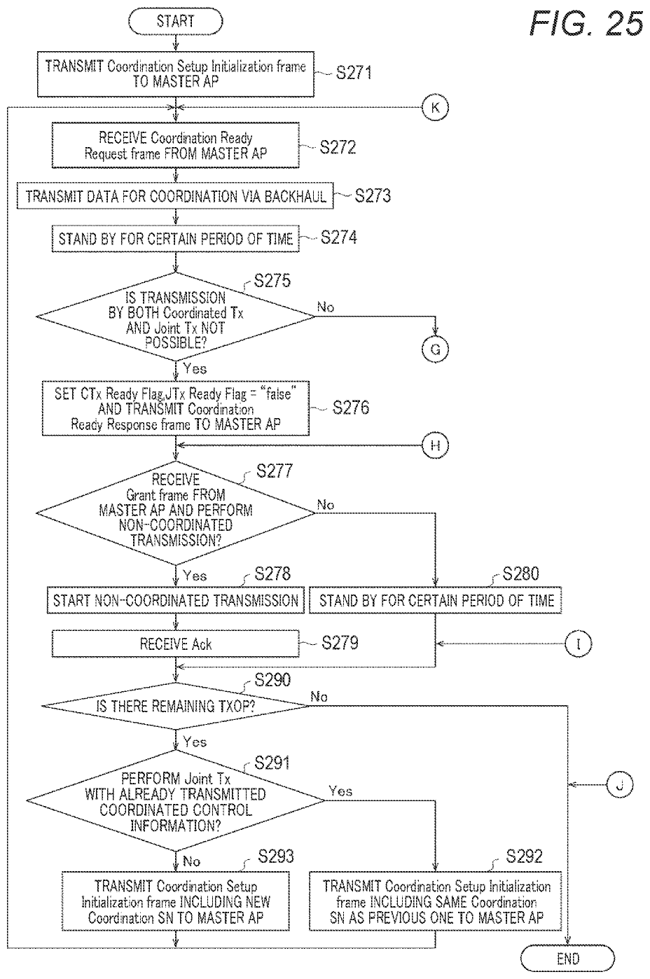

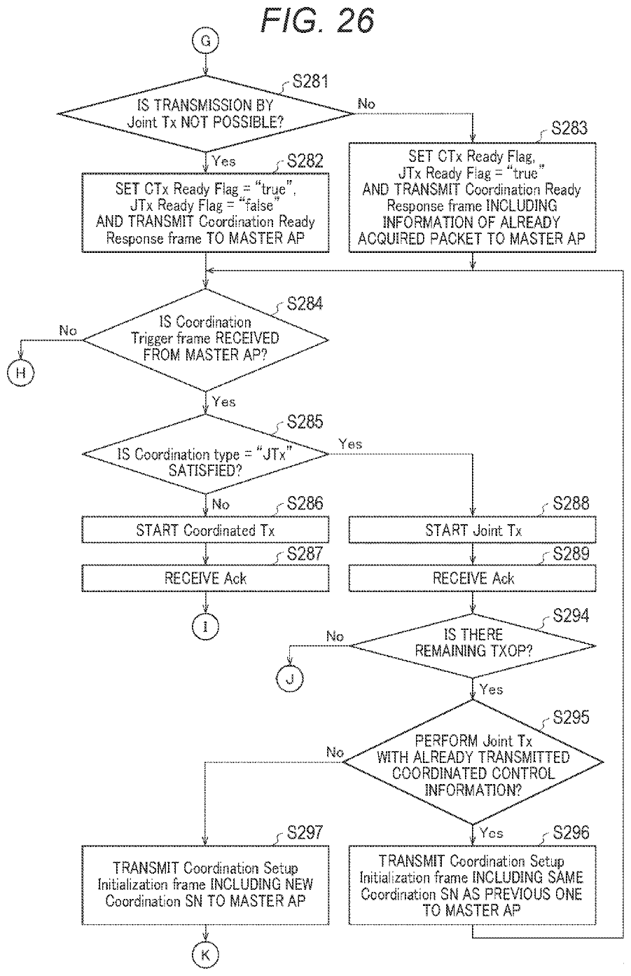

Next, a flow of processing when the non-Master AP becomes the Sharing AP in the second embodiment will be described with reference to flowcharts in FIGS. 25 and 26.

At steps S271 to S297 in FIGS. 25 and 26, processing when the non-Master AP becomes the Sharing AP is performed similarly to steps S101 to S126 in FIGS. 14 and 15, but it is different in that the processing at step S273 in FIG. 25 is added and the processing at step S283 in FIG. 26 is performed in place of the processing at step S112 in FIG. 15.

At step S273 in FIG. 25, after receiving the Coordination Ready Request frame (FIG. 20) addressed to the non-Master AP itself, the non-Master AP transmits (the packet storing) the data for coordination via the backhaul on the basis of the information (the packet information regarding the packet requested to be shared) included in the Joint Tx Packet Info To Be Shared of which notification is provided by the frame.

At step S283 in FIG. 26, when generating the Coordination Ready Response frame (FIG. 21) to transmit to the Master AP, the non-Master AP includes, in addition to the flag information, an acquisition status of (the packet storing) the data for coordination and information regarding (the packet storing) the acquired data for coordination in the Ready JTx Packet Info.

### Ninth Processing Example: Master AP=Shared AP

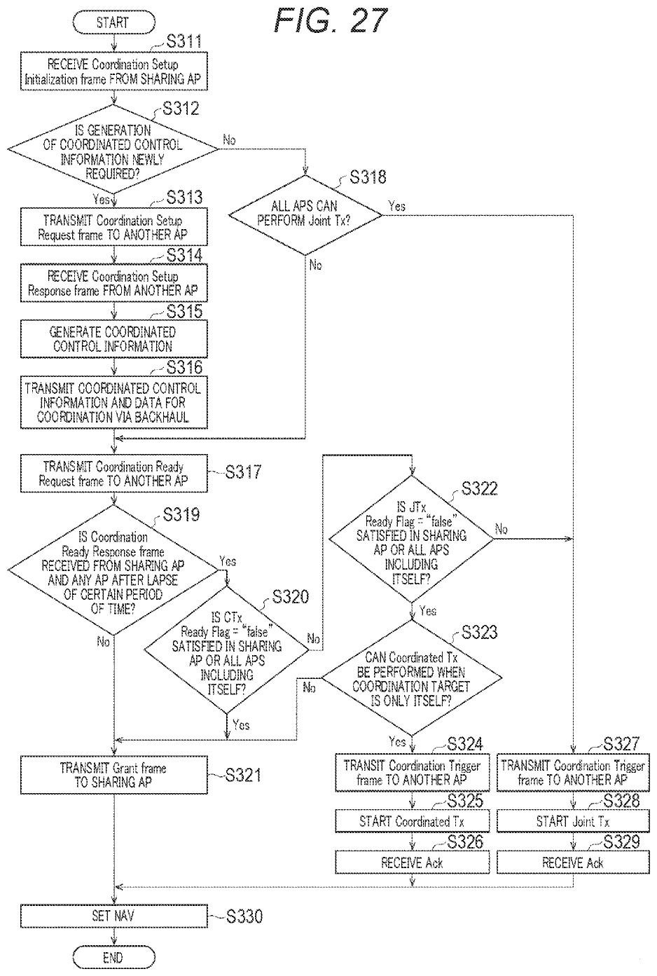

Next, a flow of processing when the Master AP becomes the Shared AP will be described with reference to a flowchart in FIG. 27.

At steps S311 to S330 in FIG. 27, processing when the Master AP becomes the Shared AP is performed similarly to steps S141 to S160 in FIG. 16, but it is different in that the processing at step S316 in FIG. 27 is performed in place of the processing at step S146 in FIG. 16 and the processing at step S322 in FIG. 27 is performed in place of the processing at step S152 in FIG. 16.

At step S316 in FIG. 27, the Master AP transmits the coordinated control information to another access point AP requested to perform the coordinated transmission via the backhaul, and at the same time, transmits the data for coordination held by the Master AP itself together.

At step S322 in FIG. 27, the Master AP determines whether JTx Ready Flag=“true” is satisfied for the Sharing AP and at least one access point AP and whether or not it is possible to acquire (the packet storing) the data for coordination and perform the Joint Tx. That is, for the Sharing AP and at least one access point AP, in a case where JTx Ready Flag=“true” is satisfied, the Master AP performs the Joint Tx performing processing only when the Sharing AP can acquire (the packet storing) the data for coordination transmitted by at least one access point AP of the corresponding access points APs (“No” at S322) (S327 to S329).

### 3. Extension Example

In the above-described embodiments, an example in which the coordinated control information is exchanged between the access points APs via the wired LAN is described, but the backhaul connecting the access points APs is not limited thereto, and for example, another wireless system may be used, or it is possible to be connected by wireless communication using a wireless LAN module operating independently of the fronthaul. Moreover, the backhaul may be wireless transmission using a millimeter wave band.

In a case of a configuration such that simple cooperation between the fronthaul and the backhaul is possible, it is possible to notify the fronthaul side of a predicted transmission delay on the backhaul side. For example, when the access point AP1 transmits the Coordinated Ready Request frame to the access point AP2, the standby time may be determined on the basis of an expected amount of delay on the backhaul side of the access point AP1, or the frame exchange between the Coordinated Ready Request frame and the Coordinated Ready Response frame may be skipped.

Furthermore, in the above-described embodiment, it is supposed that the schedule information included in the coordinated control information is also transmitted via the backhaul, but the schedule information may be transmitted via the fronthaul because a data size thereof is relatively small.

The Coordinated Ready Request frame and the Coordinated Ready Response frame may be exchanged on the backhaul. However, in this case, when a delay occurs in the backhaul, it might be supposed that a large amount of time is required until the Coordinated Ready Response frame is returned.

In the above-described embodiment, the joint transmission (Joint Tx) and coordinated transmission (Coordinated Tx) are exemplified as the coordinated transmission scheme, but other coordinated transmission schemes may be used. Furthermore, in the above-described embodiment, the configuration in which two access points AP2 are provided is described, but it is also applicable to a configuration in which three or more access points AP2 are provided.

As described above, in the communication device 10 to which the present technology is applied, the following processing is performed by at least one control unit of the control unit 100 or the communication control unit 111.

That is, in the communication device 10 (for example, the Master AP), control is performed to exchange control information (for example, the coordinated control information) used when performing coordinated transmission (for example, the Joint Tx and Coordinated Tx) in which a plurality of communication devices performs data transmission in a coordinated manner with a first other communication device (for example, another access point AP) that coordinates by using a first transmission channel (for example, the backhaul) different from a second transmission channel (for example, the fronthaul) used for wireless communication with a second other communication device (for example, the wireless terminal STA) serving as a transmission destination of data and transmit a request signal (for example, the Coordination Ready Request frame) that requests notification of an acquisition status of the control information to the first other communication device. Then, in the communication device 10 (for example, the Master AP), control to receive a response signal (for example, the Coordination Ready Response frame) that is a response to the request signal transmitted from the first other communication device is performed, and processing according to the acquisition status of the control information (for example, the processing of selecting the transmission scheme including the non-coordinated transmission and coordinated transmission such as the Joint Tx and Coordinated Tx) is performed on the basis of information included in the response signal.

Furthermore, in the communication device 10 (for example, the non-Master AP), control is performed to exchange control information (for example, the coordinated control information) used when performing coordinated transmission (for example, the Joint Tx and Coordinated Tx) in which a plurality of communication devices performs data transmission in a coordinated manner with a first other communication device (for example, another access point AP) that coordinates by using a first transmission channel (for example, the backhaul) different from a second transmission channel (for example, the fronthaul) used for wireless communication with a second other communication device (for example, the wireless terminal STA) serving as a transmission destination of data, receive a request signal (for example, the Coordination Ready Request frame) that requests notification of an acquisition status of the control information transmitted from the first other communication device, and transmit a response signal (for example, the Coordination Ready Request frame) including the acquisition status of the control information to the first other communication device on the basis of information included in the request signal.

Furthermore, in the communication device 10 (for example, the wireless terminal STA), control to set and update a transmission suppression period (NAV) is performed on the basis of a request signal (for example, the Coordination Ready Request frame) that requests notification of an acquisition status of control information used when performing the coordinated transmission and a response signal (for example, the Coordination Ready Response frame) that is a response to the request signal transmitted from another communication device (for example, the communication device of OBSS) when operating as a communication device serving as a transmission destination of data transmitted from a plurality of communication devices (a plurality of access points APs) that performs coordinated transmission (for example, the Joint Tx and Coordinated Tx) in which data transmission is performed in a coordinated manner.

In this manner, in the present technology, even in a case where an unpredictable delay occurs in the backhaul network in a plurality of access points APs that transmits the coordinated control information via the backhaul, since the acquisition status of the coordinated control information of the access points APs that are the coordination candidates is checked, it is possible to perform data transmission by using non-coordinated transmission or coordinated transmission such as the Coordinated Tx without standing by until the coordinated control information entirely reach. As a result, the coordinated transmission can be performed more flexibly. Furthermore, since the time efficiency is improved, the system capacity can be improved.

For example, even if the access points are connected by a high-speed backhaul, there is a possibility that a delay occurs until the transmitted information reaches depending on a situation such as an insufficient supporting speed of a wired cable, occurrence of a queuing delay in an L2 switch positioned at a higher level, or execution of beam training by millimeter wave communication. In this case, the access point AP has to stand by for the data transmission to the wireless terminal STA until the information exchange is completed via the backhaul, which causes an overhead and deteriorates the system capacity; however, in the present technology, since the acquisition status of the coordinated control information is checked, the data transmission can be performed using the non-coordinated transmission or the coordinated transmission such as the Coordinated Tx without standing by until the coordinated control information entirely reaches.

Moreover, in the second embodiment, by managing the state of packet sharing required for performing the Joint Tx in units of packets, it is possible to sequentially perform the Joint Tx from the packet that can be acquired in the coordinated access point AP.

Note that, a series of processing of the communication device 10 described above can be executed by hardware or software. In a case where the series of processing is executed by the software, a program that forms the software is installed on the communication device 10.

Furthermore, the embodiment of the present technology is not limited to the above-described embodiments and various modifications may be made without departing from the gist of the present technology. For example, each embodiment is described above with reference to the sequence diagrams, frame configuration diagrams, and flowcharts, but these embodiments are not necessarily limited to the illustrated configurations, and may be selectively used according to a situation. Moreover, the effect described in this specification is illustrative only and is not limitative; there may also be another effect.

Note that, the present technology may also have a following configuration.

(1)

A communication device including:

a control unit that performs control to:

exchange control information used when performing coordinated transmission in which a plurality of communication devices performs data transmission in a coordinated manner with a first other communication device that coordinates by using a first transmission channel different from a second transmission channel used for wireless communication with a second other communication device serving as a transmission destination of data; and

transmit a request signal that requests notification of an acquisition status of the control information to the first other communication device.

(2)

The communication device according to (1) described above, in which

the control unit

performs control to receive a response signal that is a response to the request signal transmitted from the first other communication device; and

performs processing according to the acquisition status of the control information on the basis of information included in the response signal.

(3)

The communication device according to (2) described above, in which

the control unit selects a transmission scheme including at least the coordinated transmission on the basis of the acquisition status of the control information.

(4)

The communication device according to (3) described above, in which

the control unit

performs control to store a packet to be transmitted to the second other communication device, and

selects the transmission scheme on the basis of packet information regarding the stored packet and the packet stored in the first other communication device.

(5)

The communication device according to (3) described above, in which

the control unit

performs control to store a packet of which sharing is requested by the first other communication device; and

selects the transmission scheme on the basis of packet information regarding the stored packet and the packet stored in the first other communication device.

(6)

The communication device according to any one of (2) to (5) described above, in which

the request signal includes packet information regarding a packet sharing of which is requested to the first other communication device when the coordinated transmission is performed.

(7)

The communication device according to any one of (1) to (6), in which

the request signal includes processing information indicating a processing number when the coordinated transmission is performed.

(8)

The communication device according to any one of (1) to (7), in which

the request signal includes time information regarding acquisition of the response signal that is the response to the request signal.

(9)

The communication device according to any one of (1) to (8) described above configured as an access point having a function of generating transmission weight information and transmitting the transmission weight information to another access point when performing the coordinated transmission, in which

the first other communication device is an access point that does not have the function,

the second other communication device is a wireless terminal,

the first transmission channel is a backhaul link, and

the second transmission channel is a fronthaul link.

(10)

A communication device including:

a control unit that performs control to:

exchange control information used when performing coordinated transmission in which a plurality of communication devices performs data transmission in a coordinated manner with a first other communication device that coordinates by using a first transmission channel different from a second transmission channel used for wireless communication with a second other communication device serving as a transmission destination of data;

receive a request signal that requests notification of an acquisition status of the control information transmitted from the first other communication device; and

transmit a response signal including the acquisition status of the control information to the first other communication device on the basis of information included in the request signal.

(11)

The communication device according to (10) described above, in which

the response signal includes preparation state information indicating whether or not preparation for one or a plurality of coordinated transmissions is completed.

(12)

The communication device according to (11) described above, in which

the control unit generates the preparation state information on the basis of the acquisition status of the control information.

(13)

The communication device according to (12), in which

the control unit

performs control to store a packet to be transmitted to the second other communication device, and

selects a transmission scheme at least including the coordinated transmission on the basis of packet information regarding the stored packet.

(14)

The communication device according to any one of (10) to (13) described above, in which

the response signal includes packet information regarding a packet shared by the first other communication device to be acquired.

(15)

The communication device according to any one of (10) to (14) described above, in which

the control unit starts transmission of data used in the coordinated transmission by using the first transmission channel on the basis of packet information regarding a packet sharing of which is requested by the first other communication device included in the request signal.

(16)

The communication device according to any one of (10) to (15) described above, in which

the response signal includes processing information indicating a processing number when the coordinated transmission is performed.

(17)

The communication device according to any one of (10) to (16) described above, in which

the control unit transmits the response signal on the basis of time information regarding acquisition of the response signal included in the request signal.

(18)

The communication device according to any one of (10) to (17) configured as an access point not having a function of generating transmission weight information and transmitting the transmission weight information to another access point when performing the coordinated transmission, in which

the first other communication device is an access point that has the function,

the second other communication device is a wireless terminal,

the first transmission channel is a backhaul link, and

the second transmission channel is a fronthaul link.

(19)

A communication device serving as a transmission destination of data transmitted from a plurality of communication devices that performs coordinated transmission in which data transmission is performed in a coordinated manner, the communication device including:

a control unit that

performs control to set and update a transmission suppression period on the basis of a request signal that requests notification of an acquisition status of control information used when performing the coordinated transmission and a response signal that is a response to the request signal transmitted from another communication device.

(20)

The communication device according to (19) described above, in which

the control unit sets and updates the transmission suppression period on the basis of time information regarding acquisition of the response signal included in the request signal.

### REFERENCE SIGNS LIST

10 Communication device
100 Control unit
101 Wireless communication unit
102 Storage unit
103 WAN communication unit
111 Communication control unit
112 Communication storage unit
113 Data processing unit
114 Signal processing unit
115 Wireless interface unit
116 Amplification unit
117 Antenna

1. A communication device comprising:
a control unit that performs control to:
exchange control information used when performing coordinated transmission in which a plurality of communication devices performs data transmission in a coordinated manner with a first other communication device that coordinates by using a first transmission channel different from a second transmission channel used for wireless communication with a second other communication device serving as a transmission destination of data; and
transmit a request signal that requests notification of an acquisition status of the control information to the first other communication device.

2. The communication device according to claim 1, wherein
the control unit
performs control to receive a response signal that is a response to the request signal transmitted from the first other communication device; and
performs processing according to the acquisition status of the control information on a basis of information included in the response signal.

3. The communication device according to claim 2, wherein
the control unit selects a transmission scheme including at least the coordinated transmission on a basis of the acquisition status of the control information.

4. The communication device according to claim 3, wherein
the control unit
performs control to store a packet to be transmitted to the second other communication device, and
selects the transmission scheme on a basis of packet information regarding the stored packet and the packet stored in the first other communication device.

5. The communication device according to claim 3, wherein
the control unit
performs control to store a packet of which sharing is requested by the first other communication device; and
selects the transmission scheme on a basis of packet information regarding the stored packet and the packet stored in the first other communication device.

6. The communication device according to claim 2, wherein
the request signal includes packet information regarding a packet sharing of which is requested to the first other communication device when the coordinated transmission is performed.

7. The communication device according to claim 1, wherein
the request signal includes processing information indicating a processing number when the coordinated transmission is performed.

8. The communication device according to claim 2, wherein
the request signal includes time information regarding acquisition of the response signal.

9. The communication device according to claim 1 configured as an access point having a function of generating transmission weight information and transmitting the transmission weight information to another access point when performing the coordinated transmission, wherein
the first other communication device is an access point that does not have the function,
the second other communication device is a wireless terminal,
the first transmission channel is a backhaul link, and
the second transmission channel is a fronthaul link.

10. A communication device comprising:
a control unit that performs control to:
exchange control information used when performing coordinated transmission in which a plurality of communication devices performs data transmission in a coordinated manner with a first other communication device that coordinates by using a first transmission channel different from a second transmission channel used for wireless communication with a second other communication device serving as a transmission destination of data;
receive a request signal that requests notification of an acquisition status of the control information transmitted from the first other communication device; and
transmit a response signal including the acquisition status of the control information to the first other communication device on a basis of information included in the request signal.

11. The communication device according to claim 10, wherein
the response signal includes preparation state information indicating whether or not preparation for one or a plurality of coordinated transmissions is completed.

12. The communication device according to claim 11, wherein
the control unit generates the preparation state information on a basis of the acquisition status of the control information.

13. The communication device according to claim 12, wherein
the control unit
performs control to store a packet to be transmitted to the second other communication device, and
selects a transmission scheme at least including the coordinated transmission on a basis of packet information regarding the stored packet.

14. The communication device according to claim 10, wherein
the response signal includes packet information regarding a packet shared by the first other communication device to be acquired.

15. The communication device according to claim 10, wherein
the control unit starts transmission of data used in the coordinated transmission by using the first transmission channel on a basis of packet information regarding a packet sharing of which is requested by the first other communication device included in the request signal.

16. The communication device according to claim 10, wherein
the response signal includes processing information indicating a processing number when the coordinated transmission is performed.

17. The communication device according to claim 10, wherein
the control unit transmits the response signal on a basis of time information regarding acquisition of the response signal included in the request signal.

18. The communication device according to claim 10 configured as an access point not having a function of generating transmission weight information and transmitting the transmission weight information to another access point when performing the coordinated transmission, wherein
the first other communication device is an access point that has the function,
the second other communication device is a wireless terminal,
the first transmission channel is a backhaul link, and
the second transmission channel is a fronthaul link.

19. A communication device serving as a transmission destination of data transmitted from a plurality of communication devices that performs coordinated transmission in which data transmission is performed in a coordinated manner, the communication device comprising:
a control unit that
performs control to set and update a transmission suppression period on a basis of a request signal that requests notification of an acquisition status of control information used when performing the coordinated transmission and a response signal that is a response to the request signal transmitted from another communication device.

20. The communication device according to claim 19, wherein
the control unit sets and updates the transmission suppression period on a basis of time information regarding acquisition of the response signal included in the request signal.
